(19) United States
(12) Patent Application Publication
(10) Pub. No.: US 2023/0010994 A1
(43) Pub. Date: Jan. 12, 2023

(54) IMAGE DISPLAY ELEMENT AND DEVICE

(71) Applicant: HITACHI-LG DATA STORAGE, INC., Tokyo (JP)

(72) Inventors: Hiroyuki MINEMURA, Tokyo (JP); Yumiko ANZAI, Tokyo (JP)

(21) Appl. No.: 17/782,692

(22) PCT Filed: Oct. 8, 2020
(86) PCT No.: PCT/JP2020/038161

§ 371 Date: Jun. 6, 2022

(30) Foreign Application Priority Data
Jan. 10, 2020 (JP) 2020-002825

(51) Int. Cl. F21V 8/00; G02B 27/01

(52) U.S. Cl. CPC G02B 6/0036; G02B 27/0172; G02B 6/0065; G02B 6/0016

(57) ABSTRACT

To improve luminance of image information visually recognized by a user while using plastic for a light guide plate. An image display element includes: a plastic substrate; an incident diffraction grating integrally formed on a surface of the plastic substrate and configured to diffract incident video light; an emission diffraction grating integrally formed on a surface of the plastic substrate and configured to emit the video light; and a coating layer formed on the emission diffraction grating and having a thickness of 10 nm or more and 1000 nm or less and a refractive index of 1.64 or more and 2.42 or less.

### TECHNICAL FIELD

The present invention relates to an image display element and a device that are small and lightweight and capable of performing augmented reality display by combining a light guide plate and a diffraction element.

### BACKGROUND ART

In an augmented reality image display device, a user can view not only an image to be projected but also surroundings at the same time. The projected image may overlap the real-world perceived by the user. Other uses for these displays include video games and wearable devices such as glasses. The user can visually recognize the image supplied from the projector while superimposing the image on the real world by wearing glasses or a goggle-like image display device in which a translucent light guide plate and the projector are integrated.

One of such image display devices is described in “PTL 1” to “PTL 3”. In these patent documents, the light guide plate includes a plurality of diffraction gratings having an uneven shape formed on a glass substrate. The light beam emitted from the projector is coupled to the light guide plate by the diffraction grating for incidence and propagates inside the light guide plate while being totally reflected. The light beam is totally reflected and propagated in the light guide plate while being converted into a plurality of light beams replicated by another diffraction grating, and finally emitted from the light guide plate. A part of the emitted light beam is imaged on the retina through the pupil of the user, and is recognized as an augmented reality image superimposed on an image of the real world.

In the light guide plate using such a concavo-convex diffraction grating, the wave number vector K of the light beam emitted from the projector is refracted in the light guide plate, and the wave number vector becomes K0 by Snell's law. Further, the diffraction grating for incidence converts the wave number vector into a wave number vector K1 capable of total reflection propagation inside the light guide plate. A diffraction action is received by another one or a plurality of diffraction gratings provided in the light guide plate, and the wave number vector changes each time diffraction is repeated as in K2, K3,

Assuming that a wave number vector of a light beam finally emitted from the light guide plate is K′, |K′|=|K|, and in a case where the projector is on the opposite side of the eye via the light guide plate, K′=K is satisfied. On the other hand, in a case where the projector is on the opposite side of the eye via the light guide plate, the light guide plate has the same action as the reflection mirror with respect to the wave number vector, and when the normal vector of the light guide plate is in the z direction and x, y, and z components of the wave number vector are compared, Kx′=Kx, Ky′=Ky, and Kz′=−Kz can be expressed.

The function of the light guide plate is to guide a plurality of light beams emitted from the projector while duplicating the light beams, and the plurality of emitted light beams are recognized by the user as image information equivalent to the original image. At this time, the duplicated light beam group has a wave number vector equivalent to the light beam having the video information emitted from the projector, and has a spatial extent. A part of the duplicated light beam group enters the pupil and is visually recognized by being imaged on the retina together with information of the outside world, and it is possible to provide the user with augmented reality information added to the information of the outside world.

A light beam having video information has a wave number vector whose magnitude varies depending on its wavelength. Since the concavo-convex diffraction grating has a constant wave number vector, the diffracted wave number vector K1 varies depending on the wavelength of the incident light beam, and propagates in the light guide plate at different angles. The refractive index of the glass substrate constituting the light guide plate is substantially constant with respect to the wavelength, and the range of the condition for guiding light while totally reflecting light varies depending on the wavelength of the incident light beam. Therefore, in order to make the user recognize an image with a wide viewing angle, it is necessary to stack a plurality of light guide plates different for each wavelength. In general, it is considered that the number of light guide plates is appropriately about 2 to 4, which is the number corresponding to each of R, G, and B or ±1.

The image display device described in “PTL 1” is an image display device for expanding input light in two dimensions, and includes three linear diffraction gratings. One is a diffraction grating for incidence, and the other two diffraction gratings for emission are typically disposed to overlap with each other on the front surface and the back surface of the light guide plate, and function as a diffraction grating for duplication and emission. In addition, “PTL 1” describes an example in which a diffraction grating for emission is formed on one surface by a periodic structure of a columnar photonic crystal.

In order to solve the problem that the image projected by the photonic crystal in “PTL 1” has high luminance in the central portion of the visual field, the image display device described in “PTL 2” discloses a technique of configuring the shape of the optical structure with a plurality of linear side surfaces.

In the image display devices described in “PTL 3” and “PTL 4”, three diffraction gratings also serving as an incident diffraction grating, a deflection diffraction grating, and an emission diffraction grating are disposed without overlapping regions in a light guide plate. “PTL 3” discloses an overhung triangular diffraction grating in order to increase diffraction efficiency of the incident diffraction grating.

“PTL 5” and “PTL 6” disclose techniques using two reflection-type volume holograms for incidence and emission as diffraction gratings formed on a light guide plate. In these, a reflection-type volume hologram is formed by multiplexing diffraction gratings corresponding to a plurality of wavelengths in a space, and diffracts light beams of a plurality of wavelengths at the same angle, unlike the concavo-convex diffraction gratings in “PTL 1” to “PTL 3”. Therefore, the user can recognize the RGB image with one light guide plate. On the other hand, in the above concavo-convex diffraction grating, a wide viewing angle can be realized because the light beam is replicated in a two-dimensional direction in the light guide plate, whereas the reflection-type volume hologram has a feature that the viewing angle is relatively narrow because only a one-dimensional replication function is provided.

### CITATION LIST

### Patent Literature

PTL 1: JP 2017-528739 A

PTL 2: WO 2018/178626 A1

PTL 3: WO 2016/130342 A1

PTL 4: WO 99/52002 A1

PTL 5: JP 2007-94175 A

PTL 6: JP 2013-200467 A

### SUMMARY OF INVENTION

### Technical Problem

Hereinafter, a light guide plate having a concavo-convex diffraction grating as the light guide plate will be described. In addition, in order to facilitate understanding, the inversion of the image by the lens action of the eye and the effect of processing the image projected on the retina with the brain and further inverting and recognizing the image are omitted, and the relationship between the pixel position and the luminance will be discussed for the projection image projected on the front screen from the video light source disposed on the same side as the eye with respect to the light guide plate. The actually visually recognized image is vertically inverted with respect to this.

“PTL 1” relates to a substrate material of a light guide plate, and discloses a technique using a glass material as illustrated in FIG. 15A. Regarding the diffraction grating, as described in paragraph 0017 thereof, a technique of forming a waveguide (=glass plate) surface by etching is disclosed. In addition, as described in paragraph 0039, “PTL 1” discloses a technique of forming two emission diffraction gratings on one surface using a photonic crystal. In a case where a cylindrical structure similar to the photonic crystal of “PTL 1” is to be formed by an injection molding method, as described later, the refractive index of the cylinder is equal to that of the waveguide (or the substrate). In this case, if the aspect ratio that is the ratio of the diameter to the height of the cylinder is not about 2 or more, the luminance of the projection image becomes insufficient.

In the photonic crystal in which the central portion of the projection image is improved to have high luminance described in “PTL 2”, the optical structure is configured by a plurality of linear side surfaces in order to solve the problem that the image projected by the linear photonic crystal rather than the cylindrical photonic crystal has high luminance at the central portion of the visual field. In “PTL 2”, as described line 34 on page 1, the high luminance portion in the stripe shape in the central portion is improved. Note that WO 2016/020643 cited in “PTL 2” is the same as “PTL 1”. In “PTL 2”, the stripe-shaped high luminance portion in the central portion, which is a problem, is not explicitly disclosed in the drawings and the like.

The cross-sectional shape of the incident diffraction grating disclosed in FIG. 5C of “PTL 3” has an overhanging triangular cross section, and it is possible to efficiently couple the video light beam incident from the upper direction (air side) in the drawing to the inside of the hatched light guide plate.

In general, in an image display element, a light beam having video information is coupled by an incident diffraction grating provided in a light guide plate so as to have a wave number capable of total reflection light guide in the light guide plate, and propagates in the light guide plate. A part of the light beam intersecting the emission diffraction grating is diffracted, and emitted from the light guide plate with a wave number equivalent to the original video light beam. The video information provided to the user has travel angle information corresponding to a pixel position of the original video information, that is, a wave number. In order for the video information of one pixel to be emitted from the light guide plate and reach the pupil of the user, it is necessary to be emitted from a specific position in the light guide plate that is determined by the traveling angle, the distance between the light guide plate and the pupil of the user, and the size of the pupil of the user. As described above, in the light guide plate, the light beam is replicated and spatially spread and emitted, so that the light beam visually recognized by the user decreases as the spatial spread increases, and the luminance visually recognized decreases. On the other hand, since the emission position visually recognized by the user changes depending on the pixel position of the original video information, it is inevitable that the luminance changes depending on the pixel position in the image display device using the light guide plate.

In the above-described prior art, it has been suitable to use a method of directly etching a glass substrate for producing a light guide plate, a nanoimprint method suitable for forming a pattern having a high aspect ratio, or the like. When the structures of the photonic crystals of “PTL 1” and “PTL 2” based on the “PTL 1” are obtained by injection molding of plastic, it is necessary to set, in the photonic crystal, an aspect ratio, which is a ratio between a representative length such as a diameter of a bottom surface and a height thereof, to about 2 or more.

Here, in a case where glass is used for the light guide plate as disclosed in “PTL 1” or the like, there are problems in processing cost and weight at the time of mounting by the user. Therefore, this problem can be solved by using plastic for the light guide plate. In the present specification and the like, the terms “resin” and “plastic” are used synonymously. The plastic means a material made of a polymer compound, does not contain glass, and is a concept including a resin, polycarbonate, an acrylic resin, and a photocurable resin.

When plastic is used for the light guide plate, the diffraction grating can be formed by an injection molding technique or the like that has been used as a manufacturing method of the optical disk medium. Since the aspect ratio of the surface-uneven pattern formed by an injection molding technique or the like does not exceed 1, the accuracy of pattern transfer decreases at an aspect ratio of 2 or more, and it is difficult to apply the pattern transfer. This is a problem caused by the principle of the essential manufacturing method in which molten polycarbonate resin, acrylic resin, polyolefin resin, and the like have high viscosity, and the resin does not accurately enter unevenness having a high aspect ratio formed with a nanometer period. In addition, since the incident diffraction grating of “PTL 3” uses an overhung triangular diffraction grating, it cannot be applied because the mother plate (stamper) and the light guide plate cannot be peeled off by the injection molding technique or the like.

The plastic light guide plate has smaller mechanical strength (Young's modulus) than the conventional glass light guide plate, and thus deformation due to environmental temperature or atmospheric pressure becomes large. Although details will be described later, it is effective to adopt a transmission-type optical configuration in which the image source and the user are located on the opposite side with the light guide plate interposed therebetween. Therefore, a configuration capable of avoiding a decrease in luminance of image information visually recognized by the user even in the transmission-type optical configuration is desirable.

As described above, in order to apply the plastic light guide plate to the image display element, it is necessary to have a configuration in consideration of a manufacturing method and luminance of image information. Therefore, an object of the present invention is to improve luminance of image information visually recognized by a user while using plastic for a light guide plate.

### Solution to Problem

A preferred aspect of the present invention is an image display element including: a plastic substrate; an incident diffraction grating integrally formed on a surface of the plastic substrate and configured to diffract incident video light; an emission diffraction grating integrally formed on a surface of the plastic substrate and configured to emit the video light; and a coating layer formed on the emission diffraction grating and having a thickness of 10 nm or more and 1000 nm or less and a refractive index of 1.64 or more and 2.42 or less.

A preferred aspect of the present invention is an image display element including: a plastic substrate; an incident diffraction grating integrally formed on a surface of the plastic substrate and configured to diffract incident video light; an emission diffraction grating integrally formed on a surface of the plastic substrate and configured to emit the video light; and a coating layer in which two types of dielectric materials are alternately stacked for N (N is a natural number) periods, d1 and d2 are film thicknesses of these dielectric materials, d1+d2 is substantially equal to H, and (d1+d2)×N is 1000 nm or less, where H is a period height of an uneven pattern of the incident diffraction grating.

Another preferred aspect of the present invention is an image display device on which the image display element is mounted, in which the incident diffraction grating and the emission diffraction grating are formed on a first surface of a plastic substrate, and video light is incident from a second surface side opposite to the first surface of the plastic substrate so that the video light can be visually recognized from the first surface side of the plastic substrate.

### Advantageous Effects of Invention

According to the present invention, it is possible to improve the luminance of the image information visually recognized by the user while using plastic for the light guide plate.

### BRIEF DESCRIPTION OF DRAWINGS

FIG. 1A is a schematic cross-sectional view illustrating a light guide plate of an embodiment.

FIG. 1B is a schematic cross-sectional view illustrating the light guide plate of the embodiment.

FIG. 2 is an image diagram illustrating an example of a phase function of an emission diffraction grating.

FIG. 3 is a perspective view of a mesh-type diffraction grating of an embodiment.

FIG. 4 is a conceptual diagram illustrating a definition of an emission circle as a basis of simulation.

FIG. 5 is an image diagram illustrating a simulation result of an intensity distribution of a light beam propagating inside the light guide plate.

FIG. 6 is a schematic cross-sectional view illustrating a configuration of an image display element of an embodiment.

FIG. 7 is a schematic plan view illustrating a relationship between a diffraction grating of a light guide plate and a wave number vector.

FIG. 8 is an image diagram illustrating a simulation result of a projection image.

FIG. 9 is an image diagram of a simulation result showing a diffracted light beam of an incident diffraction grating.

FIG. 10A is a schematic view of an example of an image display element in which incident light and emitted light are on the same side of the light guide plate.

FIG. 10B is a schematic view of an example of an image display element in which incident light and emitted light are on opposite sides of the light guide plate.

FIG. 11 is a graph illustrating simulation results of a film thickness, diffraction efficiency, and transmittance of a dielectric thin film.

FIG. 12 is a schematic view of a simulation model of an emission diffraction grating of an embodiment.

FIG. 13 is an image diagram of a visually recognized image of a user.

FIG. 14A is a graph of a simulation result of a visually recognized image of the user.

FIG. 14B is a graph of a simulation result of a visually recognized image of the user.

FIG. 14C is a graph of a simulation result of a visually recognized image of the user.

FIG. 15A is a graph illustrating a range of refractive indexes of dielectric materials.

FIG. 15B is an enlarged graph illustrating a range of refractive indexes of dielectric materials.

FIG. 16A is a graph illustrating characteristics of an emission diffraction grating with respect to a dielectric film thickness.

FIG. 16B is a graph illustrating characteristics of an emission diffraction grating with respect to a dielectric film thickness.

FIG. 16C is an enlarged graph illustrating characteristics of an emission diffraction grating with respect to a dielectric film thickness.

FIG. 17 is a table of simulation results showing RGB display images of the light guide plate of an embodiment.

FIG. 18 is a schematic cross-sectional view illustrating a configuration of an image display element of an embodiment.

FIG. 19 is a schematic view illustrating a relationship between the incident diffraction grating and diffracted light.

FIG. 20 is a schematic view illustrating a relationship between the incident diffraction grating and diffracted light.

FIG. 21 is a table illustrating a relationship between a cross-sectional shape and a period height of the incident diffraction grating.

FIG. 22A is a schematic view illustrating a simulation model of the incident diffraction grating.

FIG. 22B is a schematic view illustrating a simulation model of the incident diffraction grating.

FIG. 23A is a schematic view illustrating a simulation model of the incident diffraction grating.

FIG. 23B is a schematic view illustrating a simulation model of the incident diffraction grating.

FIG. 24A is a graph illustrating wavelength dependency of performance of the incident diffraction grating.

FIG. 24B is a graph illustrating wavelength dependency of performance of the incident diffraction grating.

FIG. 24C is a graph illustrating wavelength dependency of performance of the incident diffraction grating.

FIG. 25 is a graph illustrating a relationship between a thickness and a period height of a dielectric coating formed on the incident diffraction grating.

FIG. 26 is a schematic cross-sectional view illustrating a film shape when 13 dielectric thin films of the embodiment are stacked.

FIG. 27 is a schematic view illustrating another example of the image display element.

FIG. 28 is a schematic cross-sectional view illustrating a method for forming a light guide plate of an embodiment.

FIG. 29 is a schematic view illustrating a configuration of an image display device according to an embodiment.

### DESCRIPTION OF EMBODIMENTS

Hereinafter, embodiments of the invention will be described with reference to the drawings. However, the invention is not interpreted in a limited way to the following embodiments. A person skilled in the art can easily understand that the specific configurations may be changed within a scope not departing from the ideas and the spirit of the invention.

In the configuration of the invention described below, the same reference numerals are commonly used for the same portions or portions having similar functions in different drawings, and redundant description may be omitted.

When there are a plurality of elements having the same or similar functions, different subscripts may be given for the same reference numerals for explanation. However, when there is no need to distinguish between a plurality of elements, the description may be omitted with subscripts omitted.

The notations of “first”, “second”, and “third” in this specification are attached in order to identify the components, but not necessarily used to indicate the number, the order, or the contents. In addition, a number for identifying a component is used for each context, and a number used in one context does not necessarily indicate the same configuration in another context. In addition, it does not prevent a component identified by a certain number from also functioning as a component identified by another number.

The position, size, shape, range, and the like of each element illustrated in the drawings and the like may not necessarily represent the actual position, size, shape, range, and the like, in order to facilitate understanding of the invention. For this reason, the invention is not necessarily limited to the position, size, shape, range, and the like disclosed in the drawings and the like.

The publications, patents, and patent applications cited herein constitute a part of the description of this specification as such.

Components expressed in the singular herein are intended to include the plural unless the context clearly dictates otherwise.

In the present embodiment, a thin film coating layer is formed on an emission diffraction grating by a sputtering method or the like to improve diffraction efficiency in a direction of a user's eye. Thus, the luminance of the image information is improved while the plastic light guide plate is applied. The upper limit of the diffraction efficiency due to the uneven pattern formed on the surface of the plastic light guide plate is mainly determined by the wavelength and pattern height of the light source and the refractive index of the plastic material, and is about 4% at the maximum as described later. By forming a thin film coating layer of a dielectric material on the emission diffraction grating, it is possible to improve the thin film coating layer about twice. Details will be described in the following embodiments.

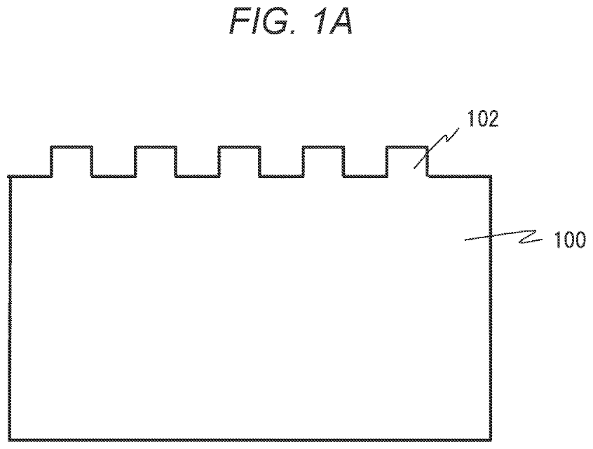

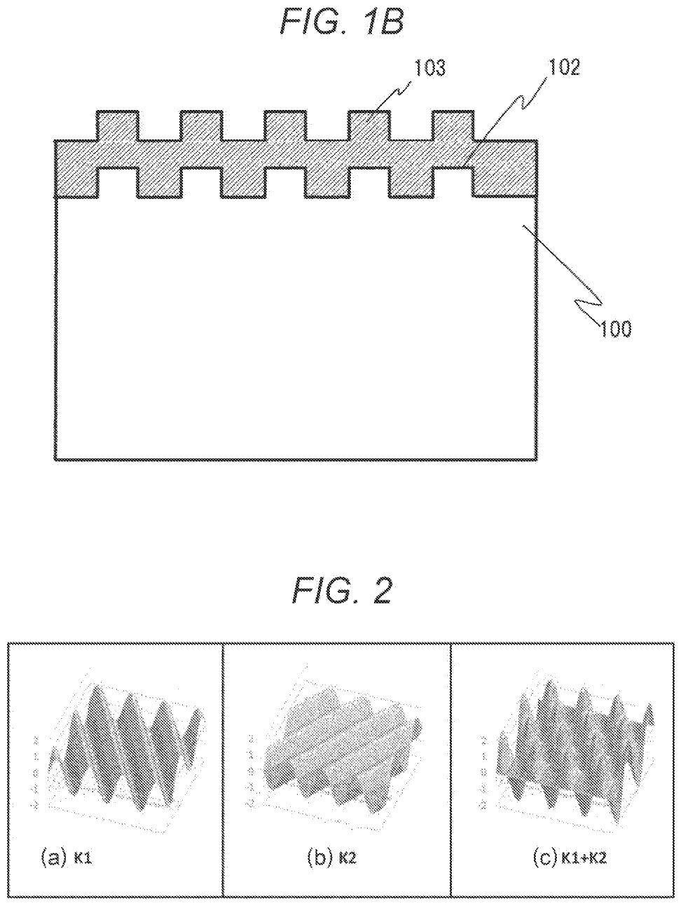

FIGS. 1A and 1B are schematic views illustrating improvement of diffraction efficiency of a transmission-type emission diffraction grating by thin film coating. FIG. 1A is a schematic view of a cross section of a plastic light guide plate. A light guide plate 100 is formed of a plastic material, and the emission diffraction grating 102 is formed as an uneven pattern on the surface. When a plastic molding technique such as an injection molding method is used, these are integrally molded and formed of the same material. However, in a plastic molding technique such as an injection molding method, the aspect ratio (height/width) of the uneven pattern of the emission diffraction grating is preferably approximately 1 or less. The phase modulation amount of the emission diffraction grating with respect to the incident light is governed by a difference between the refractive index of the plastic material of the convex portion and the refractive index of the air of the concave portion.

FIG. 1B is a schematic view in a case where a coating layer 103 is formed of a dielectric film on the surface of the emission diffraction grating 102 by a sputtering method or the like. An uneven pattern of the dielectric material is formed on the surface by reflecting the unevenness of the original diffraction grating pattern. At this time, by making the refractive index of the dielectric material to be used higher than the refractive index of the plastic material, the phase modulation amount becomes large so as to reflect the refractive index difference between the dielectric material and air. This makes it possible to obtain high diffraction efficiency even when the aspect ratio of the uneven pattern is 1 or less. Specifically, it is necessary to determine the film thickness of the dielectric material so that predetermined diffraction efficiency can be obtained by performing electromagnetic field analysis by a finite differential time domain (FDTD) method or the like. As described later, when the film thickness of the dielectric material to be formed is about from 10 nm to 200 nm, the effect of increasing the diffraction efficiency can be obtained.

In a plastic molding technique having a track record such as an injection molding method, it is easier to form the uneven pattern when the aspect ratio of the uneven pattern transferred to the surface of the light guide plate is small. As a method for reducing the aspect ratio of the uneven pattern, it is desirable to employ a diffraction grating of a two-dimensional mesh-like pattern as the emission diffraction grating 102. As a result, the aspect ratio of the uneven pattern transferred to the surface of the light guide plate easily becomes 1 or less, and it is possible to easily provide a light guide plate using a plastic molding technique having a track record such as an injection molding method.

The photonic crystal or the diffraction grating spatially applies phase modulation to incident light due to surface unevenness. The magnitude of the phase modulation increases in proportion to the difference in refractive index between the surface structure and the air and the height of the surface unevenness.

FIG. 2 schematically illustrates the wave number of the emission diffraction grating 102. The phase functions of the diffraction gratings having wave numbers K1 and K2 having an azimuth angle of ±60 degrees with respect to the Y axis are illustrated in FIGS. 2(a) and 2(b), respectively, and each has a sinusoidal phase distribution. The phase modulation amount is normalized to 1. FIG. 2(c) is obtained by synthesizing these, and it can be said that the photonic crystal described in PTL 1 or the like is formed on the surface of the light guide plate with a material having a high refractive index by approximating the photonic crystal to a pillar or the like. As can be seen from the drawing, the maximum value of the phase modulation amount of K1+K2 is 2, and when this is approximated by an isolated cylinder or the like, it is found that a height (aspect ratio) that is twice as large as that of the single sinusoidal diffraction grating of FIGS. 2(a) and 2(b) is required.

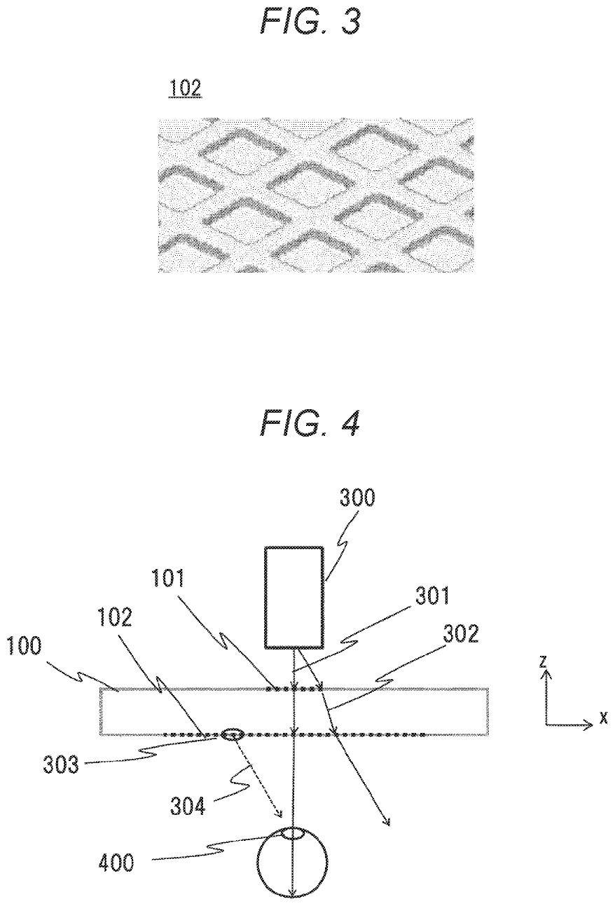

FIG. 3 is a perspective view of an embodiment in which the emission diffraction grating 102 is a mesh-like emission diffraction grating. Compared with FIG. 2(c), since the light guide plate does not have a sinusoidal structure, the light guide plate has a higher-order wave number component when subjected to Fourier transform. However, when the light guide plate is used as a light guide plate, the wave number component of the second or higher order can be made incapable of being diffracted with respect to incident light (wave number is an imaginary number) by appropriately selecting a period. In addition, the mesh-like diffraction grating is obtained by overlapping rectangular diffraction gratings of ±60 degrees, and does not have a wave number component other than the directions of the fundamental waves K1 and K2 as compared with a cylinder or the like, so that diffraction efficiency can be increased.

As a result, a two-dimensional emission diffraction grating having a small aspect ratio can be provided, and a light guide plate that is safe, lightweight, and high in image luminance can be provided by a plastic molding technique such as an injection molding method.

As will be described later, with respect to the incident diffraction grating of the present embodiment, it is desirable to achieve a low aspect ratio by using reflection having a large deflection effect on refraction by using a reflection-type diffraction grating instead of the transmission-type diffraction grating of “PTL 3”.

In the present specification, the description will proceed with a coordinate system in which the optical axis direction is the Z axis and the XY plane is taken on the surface of the light guide plate. In addition, when the pupil of the user is approximated to a circle, the emission position in the light guide plate visually recognized by the user also becomes a circle according to the pixel position. Hereinafter, this will be referred to as an emission circle.

FIG. 4 is a schematic view for explaining an emission circle. Here, a case where a projector 300 which is a light source for forming an image and the user's pupil 400 are arranged on the opposite side of the light guide plate 100 is illustrated. Assuming that the wave number vector of an incident diffraction grating 101 faces the y direction, the arrow in FIG. 4 represents a light beam in the x-z plane. Here, it is assumed that the incident diffraction grating 101 does not have a wave number vector component in the x direction.

Among the video light beams visually recognized by the user, a light beam 301 at the center of the display image corresponding to the center of the visual field goes straight in the x-z plane and is reached to the user's pupil 400 as illustrated in the drawing. Diffraction in the y direction, which is an action of the light guide plate 100, is not explicitly expressed, but occurs at least once by the incident diffraction grating 101 and the emission diffraction grating 102.

On the other hand, among the video light beams visually recognized by the user, a light beam 302 around the display image corresponding to the periphery of the visual field advances in the right direction in the drawing when there is no diffraction in the x direction. On the other hand, in order for the user to recognize this light beam as a projection image, it is necessary for light beams having the same angle to reach the user's pupil 400 through a path indicated as the light beam 304 visually recognized in the drawing. An emission circle 303 is a virtual circle on the emission diffraction grating 102 and obtained by translating the user's pupil 400 in the direction of the visually recognized light beam. Only the light beam 304 emitted from the emission circle 303 on the emission diffraction grating 102 is recognized as the projection image by the user, and the other light beams are not recognized. As described above, the diffraction action in the x direction is required for the emission diffraction grating 102.

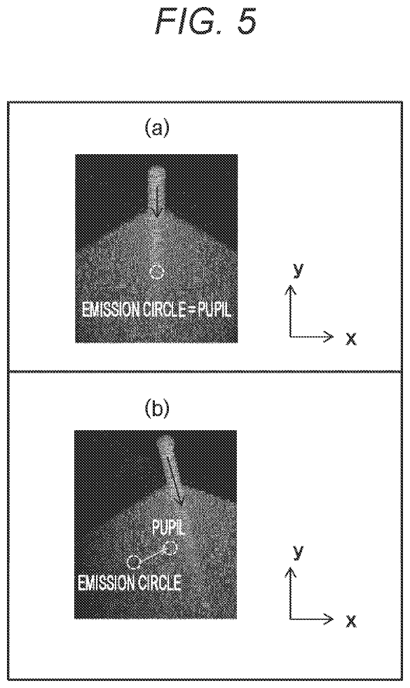

FIG. 5 is an intensity distribution of light beams propagating inside the light guide plate calculated using a simulation method to be described later. Here, it should be noted that the intensity distribution is shown in the in-plane x-y plane including the diffraction grating of the light guide plate. In the drawing, the incident diffraction grating 101 is disposed on an upper side, and a pupil corresponding to a user's eye is disposed below the incident diffraction grating.

FIG. 5(a) illustrates an intensity distribution of light toward the center of the image when the pixel position is at the center of the image to be projected. The emission circle in the drawing indicates a region where the light beam reaching the pupil is finally diffracted on the emission diffraction grating 102. A high-luminance region on a straight line extending from the incident diffraction grating 101 in the y direction indicates a main light beam group (hereinafter, main light beam group) diffracted by the incident diffraction grating 101 and propagating inside the light guide plate. As can be seen in the drawing, it has a characteristic that the intensity gradually attenuates due to the propagation of the main light beam group. The light beam group with low luminance spreading around the main light beam group is a light beam group diffracted by the emission diffraction grating 102 and whose traveling direction is deflected in the x-y plane. Under this condition, since the projected light beam is in the z-axis direction, it is found that the emission circle and the pupil coincide with each other in the x-y plane. Therefore, a part of the main light beam group with high intensity is reached to the pupil and recognized as an image.

FIG. 5(b) illustrates the intensity distribution of the light to the periphery of the image in the case of the pixel position at the upper right corner of the projection image. As can be seen in the drawing, the main light beam group travels from the incident diffraction grating 101 toward the lower right direction. Although the position of the pupil is constant, the emission circle is the emission position of the light beam group traveling to the upper right toward the pupil. Therefore, the emission circle is shifted to the lower left with respect to the pupil in the x-y plane. In this case, since the emission circle is located away from the main light beam group, the light beam group that reaches the pupil and is recognized as an image has lower luminance than the above case. The above is the main reason why luminance unevenness occurs when an image is projected using the light guide plate 100.

When the grating pitch is P, the magnitude of the wave number vector of the diffraction grating is expressed by K=2π/P. When expressed in a coordinate system in which the optical axis direction is taken as the z axis, a wave number vector of the incident diffraction grating 101 is K₁=(0, −K, 0). The emission diffraction grating 102 has two wave number vectors with an angle of 120 degrees, which are K₂=(+K/√3, K/2, 0) and K3=(−K/√3, K/2, 0). When the wave number vector of the light beam incident on the light guide plate 100 is kⁱ=(kⁱₓ, kⁱ_{y}, kⁱ_{z}), the wave number vector of the light beam to be emitted is k^{o}=(k^{o}ₓ, k^{o}_{y}, k^{o}_{z}), and K₁, K₂, and K₃ are sequentially applied to kⁱ, k^{o}=kⁱ is obtained as follows, and it can be seen that the light beam having the same wave number vector as the incident light beam, that is, the light beam having the same video information is emitted.

k^{o}=kⁱ

k^{o}ₓ=kⁱₓ+0+(K/√3)−(K/√3)=kⁱₓ

k^{o}_{y}=kⁱ_{y}+K−(K/2)−(K/2)=kⁱ_{y}

k^{o}_{z}=kⁱ_{z}

Next, a simulation method for analyzing the image display element of the embodiment will be briefly described. The ray-tracing procedure [G. H. Spencer and M. V. R. K. Murty, “General Ray-Tracing Procedure”, J. Opt. Soc. Am. 52, p. 672 (1962).] proposed by G. H. Spencer et al. in 1962 is a method for calculating an image or the like observed at a certain point by tracing a path focusing on the particle properties of light, and has been vigorously improved mainly in the field of computer graphics. The Monte Carlo ray-tracing procedure [I. Powell “Ray Tracing through system containing holographic optical elements”, Appl. Opt. 31, pp. 2259-2264 (1992).] based on the ray-tracing procedure is a method for stochastically treating path separation due to diffraction, reflection, or the like to prevent an exponential increase in the amount of calculation, and is suitable for simulation of a light guide plate that repeats diffraction and total reflection propagation. In the Monte Carlo ray-tracing procedure, reflection and refraction can be sufficiently reproduced, but it is essential to develop a suitable model for diffraction.

In a light guide plate for a head mounted display, a diffraction model corresponding to a wavelength range (about 400 to 700 nm) over the entire visible light region and an incident angle range corresponding to a viewing angle (about 40°) of a projection image is essential, and a calculation amount becomes enormous in a commercially available simulator. Here, in view of the fact that the visually recognized light beam is a part of the total light beam, an algorithm is used in which the calculation amount is reduced to 1/1000 or less by an algorithm for stopping the calculation of the light beam guided to a region not visibly recognized in advance. The angle and wavelength dependency of the diffraction efficiency by the diffraction grating are based on a method in which calculation results by the FDTD method are tabulated and referred to in advance.

### First Embodiment

Hereinafter, the image display element of the embodiment will be described in detail.

<1. Overall Configuration of Image Display Element>

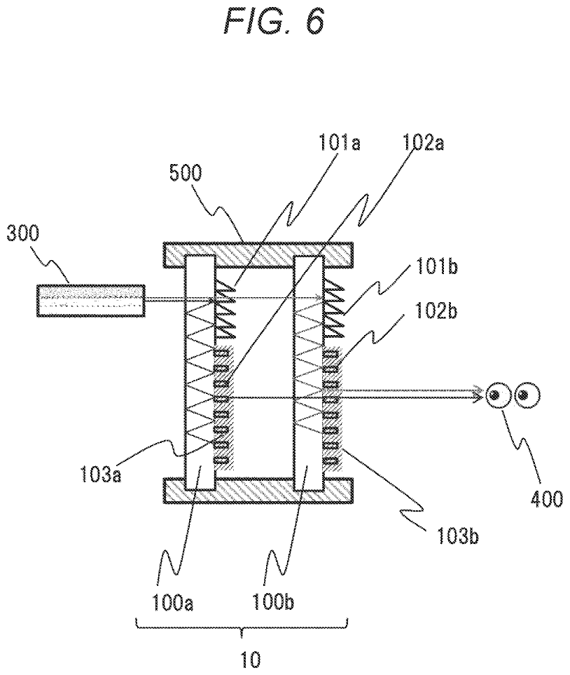

FIG. 6 illustrates a configuration of the image display element of the embodiment. Here, an image display element 10 includes two light guide plates 100a and 100b, and the incident diffraction grating 101 and the emission diffraction grating 102 are formed, respectively.

The incident diffraction grating 101 is a linear surface-concavo-convex diffraction grating. As the incident diffraction grating 101, a blazed grating having high diffraction efficiency is exemplified, but the type is not particularly limited.

Each of the emission diffraction gratings 102 has the same pattern period as that of the incident diffraction grating 101. The coating layer 103 is formed on the surface of the emission diffraction grating 102. The light guide plates 100a and 100b have different pattern periods P1 and P2, respectively, and have different corresponding wavelength ranges. In the case of P1<P2, the light guide plate 100a mainly functions for display on the short wavelength side in the wavelength range of the color image, and the light guide plate 100b mainly functions for display on the long wavelength side. P1 is, for example, 360 nm, and P2 is, for example, 460 nm. The number of the light guide plates 100 is arbitrary, and may be one, three or more according to the wavelength of the light to be handled. The pattern period of each light guide plate is desirably changed according to the wavelength to be handled.

For the reason described later, the incident diffraction grating 101 is disposed on a surface of the light guide plate 100 opposite to the incident surface of the video light. In the present embodiment, the emission diffraction grating 102 is formed on the same plane as the incident diffraction grating 101. When both diffraction gratings are formed on the same plane, one stamper may be used for forming the diffraction grating pattern, which is advantageous in terms of cost. On the other hand, the inventors have studied the diffraction efficiency of the emission diffraction grating, and found that when reflection diffraction for guiding light in the light guide plate 100 is taken into consideration, the visual luminance can be increased by allowing the user to visually recognize the first-order reflected diffracted light. When both the incident diffraction grating 101 and the emission diffraction grating 102 are disposed on a surface opposite to the incident surface of the video light as illustrated in FIG. 6, the user visually recognizes the first-order transmitted diffracted light, and a configuration for improving luminance is important. It is also possible to form the incident diffraction grating 101 and the emission diffraction grating 102 on opposite surfaces.

The shape of the emission diffraction grating 102 may be a linear stripe shape similar to that of the incident diffraction grating 101, or may be the mesh shape illustrated in FIG. 3. The mesh shape has an effect of further increasing the diffraction efficiency, but does not exclude the shapes of other diffraction gratings.

In the present embodiment, the emission diffraction grating 102 is basically formed only on one surface of the light guide plate 100. That is, in the example of FIG. 6, the surface of the light guide plate 100 opposite to the emission diffraction grating 102 is basically flat without a pattern. The surface opposite to the emission diffraction grating 102 is substantially not diffracted, and the light beam is ideally totally reflected. When one emission diffraction grating is dispersedly disposed on both surfaces of the light guide plate 100, there is a possibility that misalignment of both diffraction gratings occurs due to thermal expansion or the like of the light guide plate.

With such a configuration, the user's pupil 400 can visually recognize the image configuration emitted from the projector 300. The light from the projector 300 is incident on the image display element 10 from the side opposite to the user's pupil 400. However, the projector 300 does not need to be physically disposed on the opposite side of the user's pupil 400, and a light beam from the projector 300 disposed at an arbitrary position may be incident from an arbitrary surface of the light guide plate 100 with a mirror or the like.

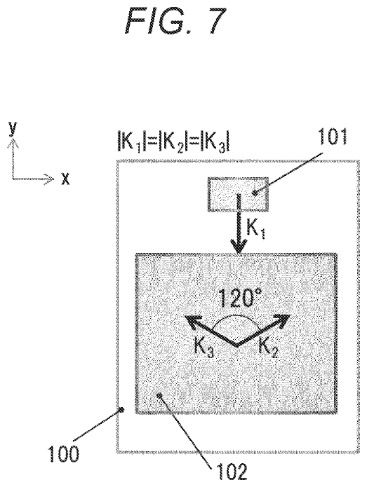

FIG. 7 illustrates an example of a relationship between wave number vectors of the incident diffraction grating 101 and the emission diffraction grating 102 formed on one light guide plate 100. As described above, in order for the light guide plate 100 to function as the image display element, the magnitudes of the wave numbers K1, K2, and K3 may be equal in the drawing, and the relationship of K1+K2+K3=0 may be satisfied.

<2. Configuration of Emission Diffraction Grating>

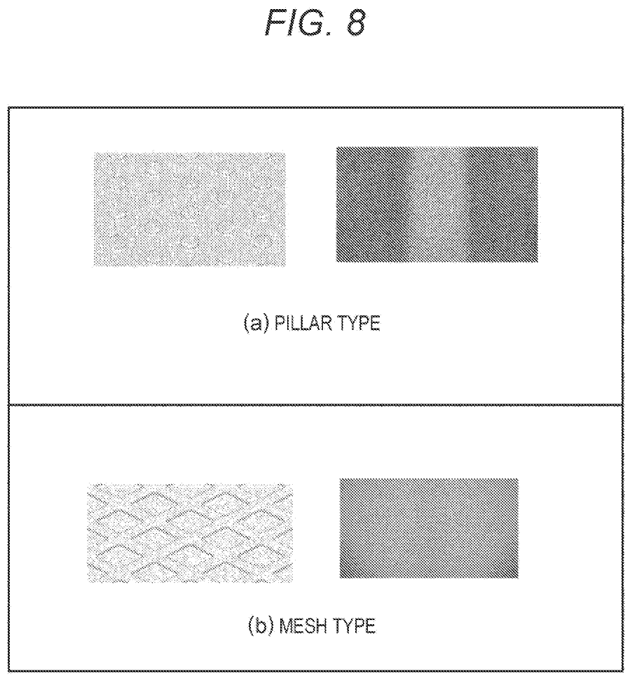

First, a specific example of the emission diffraction grating 102 will be described with reference to FIG. 8. From FIGS. 8(a) and 8(b), the projection images of the photonic crystal and the mesh-type diffraction grating in the case of the same aspect ratio of 0.8 are compared. FIG. 8(a) is a perspective view of a pillar-type photonic crystal described in “PTL 1” and a simulation result of the projection image thereof. FIG. 8(b) is a perspective view of the mesh-type diffraction grating of the present embodiment and a simulation result of the projection image thereof. Conditions other than the shape are the same. As can be seen from the drawing, in the case of the aspect ratio of 1 or less, in the photonic crystal, it can be seen that the luminance at the central portion of the projection image is high and visibility is poor. In comparison, the mesh-type diffraction grating of the present embodiment can obtain a good projection image with a low aspect ratio pattern.

In the mesh-type diffraction grating, the relationship between the pattern duty, the diffraction efficiency, and the aspect ratio has been simulated. When the pitch of the pattern of the diffraction grating is p and the width of the pattern is w, the duty is expressed by w/p. In the simulation, the pattern pitch p is 460 nm, the pattern height is 70 nm, the wavelength of the light beam is 550 nm, the thickness of the light guide plate is 1.0 mm, and the refractive index of the light guide plate is 1.58. The viewing angle of the projection image is 40 degrees.

According to the simulation results, it has been found that the first-order diffraction efficiency η1 has a maximum value of about 4.2% at w/p=0.5, and has characteristics of decreasing as w/p approaches 0 or 1. When a diffraction efficiency of about 0.6% is obtained, w/p of the mesh-type diffraction grating of the present embodiment needs to be determined in a range of 0.15 or more and 0.85 or less. The efficiency is good in the range of w/p of 0.3 or more and 0.7 or less, and the efficiency is best in the range of w/p of 0.4 or more and 0.6 or less.

Regarding the aspect ratio of the pattern, since the pattern height is fixed at 70 nm, the aspect ratio increases when w/p approaches 1 or 0. When the aspect ratio of the pattern is set to 1 or less as a reference for adaptation of an injection molding method or the like, w/p of the mesh-type diffraction grating of the present embodiment needs to be determined in the range of 0.15 to 0.85. In addition, w/p=0.5 is most easily manufactured at the minimum aspect ratio.

From the above, in principle, when w/p=0.5, that is, w=p−w, it can be said that the diffraction efficiency of the mesh-type diffraction grating is maximum and the aspect ratio of the pattern is minimum.

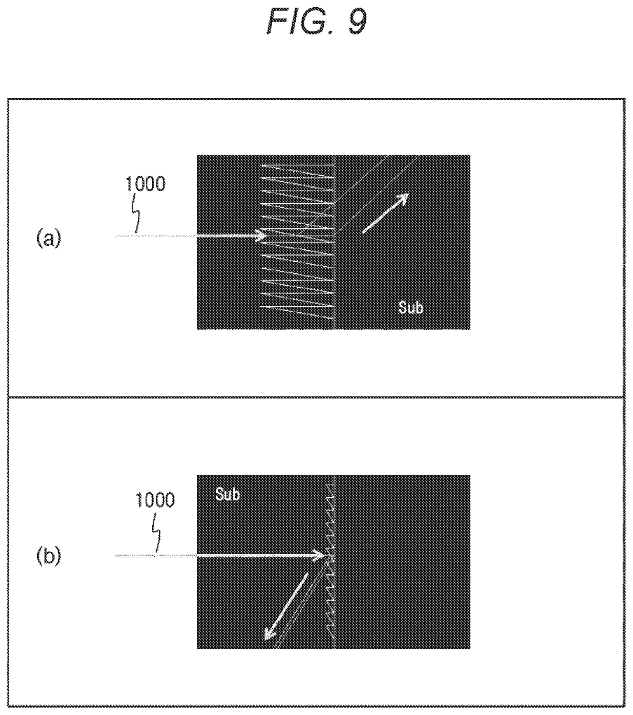

Next, a specific example of the incident diffraction grating 101 will be described with reference to FIG. 9.

<3. Configuration of Incident Diffraction Grating>

FIG. 9(a) is a simulation result of a diffraction grating of the same transmission type as that of “PTL 3”. In the transmission-type diffraction grating, incident light is transmitted and diffracted, and propagates through the inside of the light guide plate (substrate) 100. The position of the incident diffraction grating 101 is formed on a surface of the light guide plate 100 close to the light source.

A video light beam 1000 is configured to be incident from the left, and a right half of the drawing illustrates a substrate (Sub). In the transmission-type diffraction grating, the maximum diffraction efficiency is obtained under the condition that the refraction by the blaze surface and the diffraction by the periodic structure are phase-synchronized. As illustrated in the drawing, in order to realize this, the height of the uneven pattern needs to be large, the angle of the pattern needs to be 70 degrees to 80 degrees, and the aspect ratio obtained by dividing the height of the pattern by the period needs to be 10 or more. In a general plastic molding method such as injection molding, when the aspect ratio exceeds 1, problems such as deterioration of transferability occur, and the yield at the time of mass production decreases. It can be seen that the transmission-type diffraction grating illustrated here is not suitable as the incident diffraction grating of the present embodiment.

FIG. 9(b) is a simulation result of the reflection-type diffraction grating. In the reflection-type diffraction grating, incident light is reflected and diffracted, that is, reflected to the light source side and propagates inside the light guide plate (substrate) 100. The position of the incident diffraction grating 101 is formed on a surface of the light guide plate 100 far from the light source.

The video light beam 1000 is similarly incident from the left, and the left half of the drawing represents the substrate (Sub). In the reflection-type diffraction grating, the maximum diffraction efficiency is obtained under the condition that the reflection by the blaze surface and the diffraction by the periodic structure are phase-synchronized. As can be seen from the drawing, it can be seen that this condition is satisfied with an uneven pattern having a lower aspect ratio than that of the transmission type. At this time, the height of the uneven pattern is about 250 nm, and the aspect ratio is about 0.57. In the above-described prototype element, a triangular uneven pattern having a pattern height of 374 nm can be satisfactorily transferred. It can be said that the incident diffraction grating suitable for the light guide plate of the present embodiment employing plastic formation is a reflection-type incident diffraction grating.

<4. Study on Influence of Inclination of Light Guide Plate>

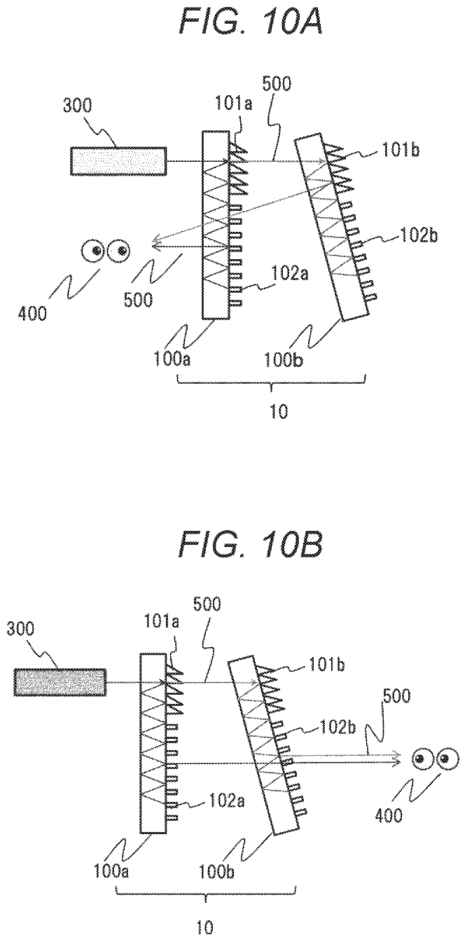

FIGS. 10A and 10B are schematic views illustrating the influence of the relative inclination of the two light guide plates 100. In FIGS. 10A and 10B, the light guide plate 100 includes the light guide plates 100a and 100b having different corresponding wavelengths. In addition, reference numeral 300 denotes a projector for image projection, reference numeral 400 denotes a pupil of the user, and reference numeral 500 denotes a video light beam to be projected.

In this example, a reflection-type diffraction grating is adopted as the incident diffraction grating based on the knowledge described in FIG. 9. Therefore, the incident diffraction grating 101 is formed on a surface (right surface in the drawing) of the light guide plate 100 far from the projector 300. The emission diffraction grating 102 can be formed on the same surface as the incident diffraction grating 101 for higher accuracy due to process convenience, and thus is formed on a surface that is also far from the projector 300.

FIG. 10A illustrates a case where the projector 300 and the user's pupil 400 are disposed on the same side with respect to the light guide plate 100. As illustrated in the drawing, the light guide plate 100 finally reflects the video light beam 500 to reach pupil 400 of the user. Therefore, when the light guide plate 100b is inclined as compared with the light guide plate 100a, the visually recognized pixel position is shifted by the wavelength of the projected light beam, and the image quality is deteriorated. Since the resolution capability of the light beam angle of the user with visual acuity of 1.0 is 1/60 degrees, it is necessary to make the relative inclination of the two light guide plates sufficiently smaller than 1/60 degrees based on this, and it is difficult to mount a plastic light guide plate having a smaller mechanical strength (Young's modulus) than a conventional glass plate as a head mounted display. In this case, the user can be provided with the video information with higher luminance as the reflection diffraction efficiency of the emission diffraction grating increases.

FIG. 10B illustrates a case where the projector 300 and the user's pupil 400 are disposed on the opposite side to the light guide plate 100. As illustrated in the drawing, the light guide plate 100 finally transmits the video light beam 500 to reach the user's pupil 400. Since angles of the incident light and the emitted light are basically the same, even if there is a relative inclination between the light guide plates 100a and 100b, a shift of the projection image due to the wavelength does not occur in principle. Therefore, in a case where the plastic light guide plate of the present embodiment is mounted on the head mounted display, it is desirable that the projector light source is disposed on the side opposite to the user's pupil 400 with respect to the light guide plate 100 (transmission-type optical configuration).

It should be noted that the relative inclination of the light guide plates 100a and 100b is desirably suppressed to about 3 degrees or less since the light beam angle condition for totally reflecting and guiding light inside the light guide plate is affected in practice. In this case, the user can be provided with the video information with higher luminance as the transmission diffraction efficiency of the emission diffraction grating 102 increases.

<5. Study on Improvement of Visual Luminance and Improvement of Emission Diffraction Grating>

Diffraction efficiency when light propagating through the light guide plate 100 is diffracted by the emission diffraction grating 102 and emitted from the light guide plate 100 is calculated by the FDTD method. Under the conditions that the wavelength is 550 nm, the refractive index of the light guide plate is 1.58, the pattern period of the diffraction grating is 460 nm, the width of the convex portion is 150 nm, and the height of the convex portion is 70 nm, and light corresponding to the central pixel of the projection image is coupled by incident diffraction and totally reflected and propagated inside the light guide plate, the reflection diffraction efficiency is 3.5%, and the transmission diffraction efficiency is 2.8%. The uneven pattern has an aspect ratio of 0.47. In a case where the emission diffraction grating 102 is formed on the same plane as the incident diffraction grating 101 as in FIG. 10B, the light beam visually recognized by the user is transmitted and diffracted by the emission diffraction grating 102. Therefore, in the transmission-type optical configuration illustrated in FIG. 10B, the luminance of the projection image visually recognized by the user decreases as compared with the reflection-type optical configuration in FIG. 10A.

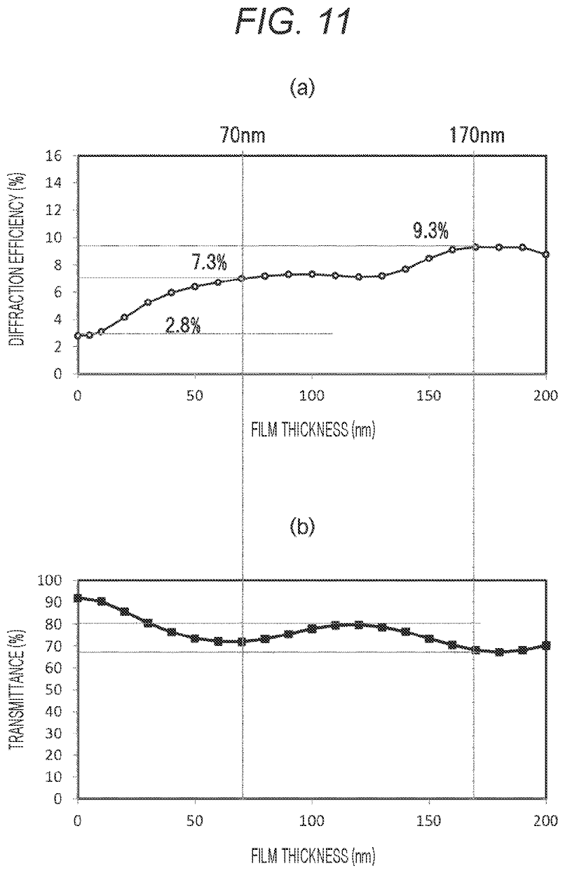

In FIG. 11, a thin film coating on the emission diffraction grating 102 is formed by a sputtering method, and as a ZnS—SiO₂ (20%) thin film (refractive index 2.33), the film thickness of the dielectric thin film is indicated on the horizontal axis, and the transmission diffraction efficiency and the transmittance of the light guide plate are indicated on the vertical axis.

Here, transmission diffraction efficiency when light propagating through the light guide plate 100 is diffracted by the emission diffraction grating 102 and emitted from the light guide plate 100 is calculated by the FDTD method. Under the condition that the wavelength is 550 nm, the refractive index of the light guide plate 100 is 1.58, the pattern period of the emission diffraction grating 102 is 460 nm, the width of the convex portion is 150 nm, and the height of the convex portion is 70 nm, the transmission diffraction efficiency is calculated under the condition that the light corresponding to the central pixel of the projection image is coupled by the incident diffraction grating 101 and totally reflected and propagated inside the light guide plate 100.

As illustrated in FIG. 11(a), by forming a dielectric thin film on the emission diffraction grating 102, transmission diffraction efficiency is improved, and video information with high luminance can be provided. In a case where visual luminance is regarded as important, when the film thickness of the dielectric film is 70 nm, the transmission diffraction efficiency is 7.3%, and it is possible to improve the efficiency by 2.5 times or more as compared with 2.8% in a case where coating is not applied. When the film thickness of the dielectric film is 170 nm, the transmission diffraction efficiency is 9.3%, and it is possible to improve the efficiency by 3 times or more as compared with 2.8% when coating is not applied.

In addition, the improvement of the diffraction efficiency also appears in the reflection diffraction efficiency, and when a film thickness of about 20 nm or more is formed, the reflection diffraction efficiency can exceed the reflection diffraction efficiency in a case where coating is not applied. Therefore, even if the emission diffraction grating 102 is formed on the same plane as the incident diffraction grating 101, a large luminance can be obtained.

FIG. 11(b) illustrates a calculation result of the transmittance of the light guide plate, and corresponds to the brightness when the user visually recognizes the outside world. For example, in the case of a ZnS—SiO₂ (20%) thin film, when the thickness is 70 nm, the transmittance of the light guide plate decreases to about 72% as compared with about 91% in the case of not forming a dielectric thin film. For example, when the user uses the head mounted display of the present embodiment outdoors, there is an effect of enhancing the visibility of the projection image by reducing the intensity of the external light image to about 80% (=72%/91%) and improving the luminance of the projection image to about 2.5 times (7.3%/2.8%). In addition, when the film thickness of the dielectric film is 170 nm, the brightness of the projection image looks brighter than the outside world. According to FIG. 11(b), when the film thickness is in the range of 70 nm or more and 170 nm or less, the transmittance is 68 to 80%, and in consideration of the effect of improving the diffraction efficiency, the relative luminance of the projection image with respect to the outside world can be improved.

In general, the density and internal stress of a dielectric thin film formed by a sputtering method or the like change depending on film formation conditions such as a device, a target, a degree of vacuum, and RF (radio frequency) power. In the present embodiment, the refractive index of the dielectric thin film formed by the inventors is identified using the measurement results of the reflectance and the transmittance by the spectrophotometer. When the dielectric thin film is formed by another film forming method or devices, the refractive index may be different by about ±5%.

As a thin film material suitable for the present embodiment, dielectric materials such as ZnS, AlN, SiNx, SiO, AlON, Al₂O₃, and the like can be used in addition to ZnS—SiO₂ (20%) described herein.

According to the present embodiment, in a light guide plate (image display element) having a surface-concavo-convex diffraction grating, by forming a coating layer of a dielectric material or the like on a surface of an emission diffraction grating by a sputtering method or the like, it is possible to increase diffraction efficiency of the emitted light to 4% or more. When the mesh-type emission diffraction grating is used, plasticization of the light guide plate can be realized by an injection molding method or the like, and a light guide plate that is safe, lightweight, and high in luminance can be realized.

### Second Embodiment

In the present embodiment, an embodiment in which the display performance of the light guide plate is improved focusing on the smoothing of the luminance distribution of the image visually recognized by the user will be described.

<2-1. Study on Smoothing of Luminance Distribution>

Transmission diffraction efficiency when light propagating through the light guide plate 100 is diffracted by the emission diffraction grating 102 and emitted from the light guide plate 100 is calculated by the FDTD method, and the dependency of the transmission diffraction efficiency on the incident angle is tabulated. Using this, ray tracing is performed to obtain an image visually recognized by the user. Here, the wavelength is 635 nm, the refractive index of the light guide plate is 1.58, the pattern period of the diffraction grating is 460 nm, the width of the convex portion is 150 nm, and the height of the convex portion is 90 nm. In addition, the thickness of the light guide plate 100 is set to 1 mm, the diameter of the video light beam incident on the incident diffraction grating 101 is set to 4 mm, the distance between the incident diffraction grating 101 and the emission diffraction grating 102 is set to 5 mm, the distance from the light guide plate 100 to the user's pupil 400 is set to 25 mm, and the diameter of the user's pupil 400 is set to 3 mm.

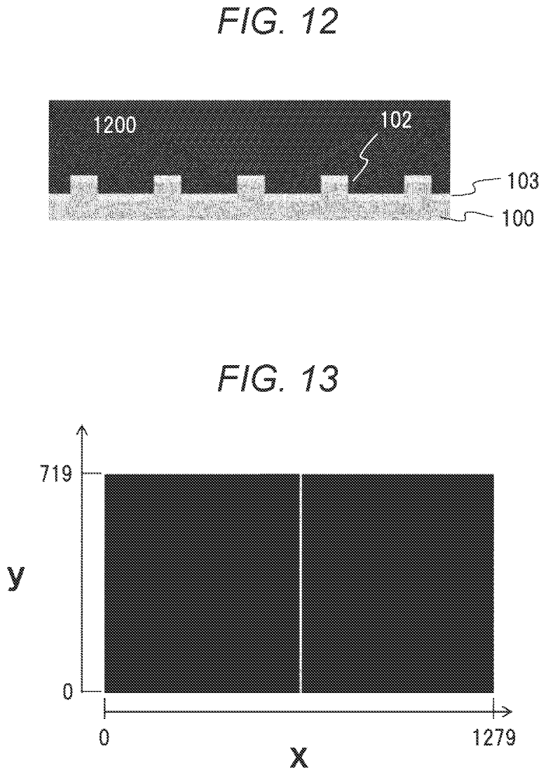

FIG. 12 is an example of an object model used for calculation. The emission diffraction grating 102 having an uneven pattern is formed on the surface of the plastic light guide plate 100, and the coating layer 103 of a dielectric thin film is formed thereon with a constant film thickness. In practice, the uneven pattern has a cross-sectional shape close to a trapezoid with an inclination angle, but here, in order to simplify the calculation model, an ideal rectangular diffraction grating is assumed as the cross-sectional shape. As the dielectric material, ZnS—SiO₂ (20%) is obtained. In the drawing, a black portion 1200 indicates an air layer.

FIG. 13 is an example of the calculated visually recognized image. A display pixel is 1280×720 pixels, and here, a horizontal direction is an X direction and a vertical direction is a Y direction. The wave number vector of the incident diffraction grating is in the Y direction. The incident angle of the video light beam and the propagation angle in the light guide plate change depending on the pixel position in the Y direction of the display image.

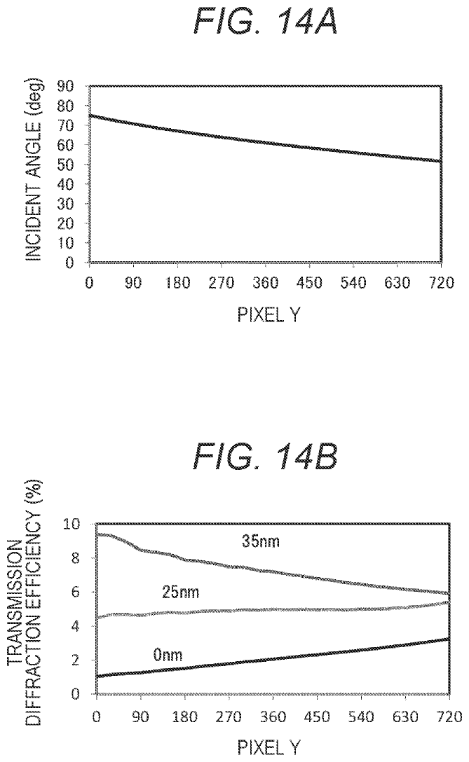

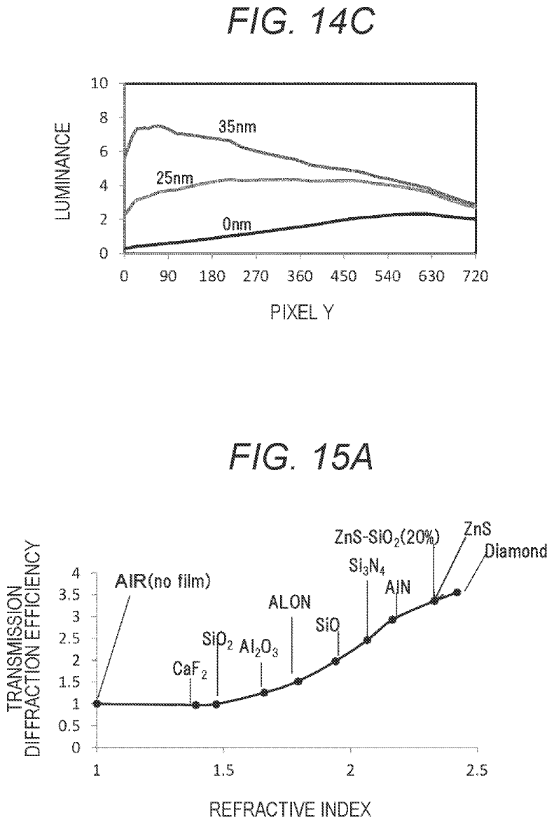

FIGS. 14A to 14C illustrate calculation results for pixel positions in the Y direction. The material of the coating layer 103 is ZnS—SiO₂ (20%).

FIG. 14A illustrates an angle of a light beam propagating inside the light guide plate 100, that is, an incident angle to the emission diffraction grating 102. It can be seen that the incident angle decreases as the pixel position increases.

FIG. 14B is a calculation result of transmission diffraction efficiency. Here, three types of cases where the film thickness of the coating layer 103 is 0, 25, and 35 nm are shown. As can be seen from the drawing, in a case where the coating layer 103 is not formed (thickness 0 nm), it can be seen that the transmission diffraction efficiency increases as the pixel position increases. On the other hand, in a case where the dielectric thin film is formed, for example, when 35 nm is formed, it is found that the transmission diffraction efficiency can be reduced as the pixel position increases. In addition, when 25 nm is formed, it is found that the transmission diffraction efficiency is relatively unchanged with respect to an increase in pixel position.

FIG. 14C illustrates a calculation result of the luminance visually recognized by the user. As can be seen in the drawing, in a case where the dielectric thin film is not formed (thickness 0 nm), the luminance remarkably increases as the pixel position increases. In addition, in a case where the dielectric film thickness is 35 nm, the luminance at the central portion is high, but the luminance remarkably decreases as the pixel position increases. On the other hand, in a case where the dielectric film thickness is 25 nm, it is possible to provide an image of a flat luminance distribution regardless of the pixel position. Therefore, when the dielectric film thickness is nm or more and less than 35 nm, both improvement in luminance and a flat luminance distribution can be achieved.

According to the present embodiment, it is possible to control the luminance distribution of the image visually recognized by the user by forming the dielectric thin film on the surface of the emission diffraction grating. In the above example, in a case where the dielectric film thickness is 25 nm, the luminance distribution can be made close to flat.

<2-2. Study of Film Material and Refractive Index>

As a thin film material suitable for the present embodiment, dielectric materials such as ZnS, AlN, SiNx, SiO, AlON, and Al₂O₃ can be used, and a mixed material of two or more dielectrics such as ZnS—SiO₂ (20%) can also be used.

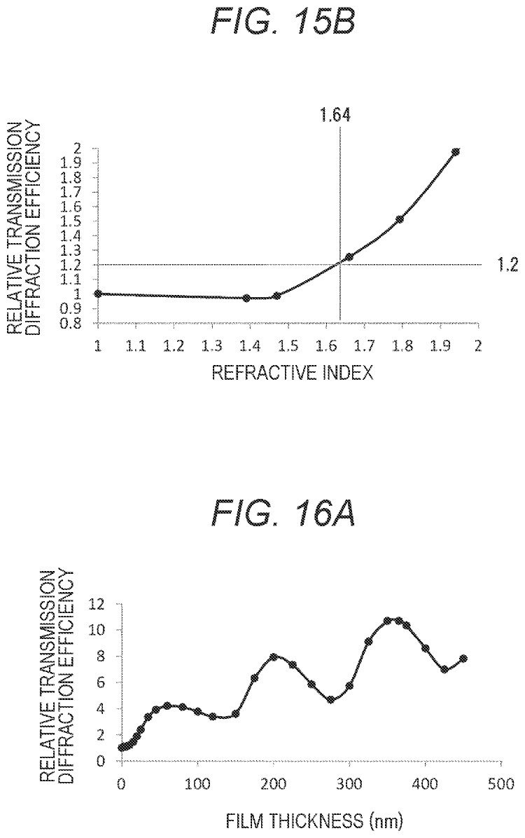

FIG. 15A is a simulation result showing a range of a refractive index of a dielectric material suitable for the present embodiment. The film thickness of the coating layer 103 formed of the various dielectric materials described above is normalized by the refractive index and set to 0.128λ in order to compare with the film thickness of ZnS—SiO₂ (20%) of 35 nm (=0.128λ, λ=635 nm).

In the drawing, the vertical axis represents the transmission diffraction efficiency involved in the improvement of the luminance at the center of the projection image, which is normalized as 1 when the coating layer 103 is not provided. As can be seen from the drawing, as the refractive index of the coating layer 103 formed on the emission diffraction grating 102 increases, the transmission diffraction efficiency increases, and there is an effect of improving the luminance of the visually recognized image.

FIG. 15B is an enlarged view of a part of FIG. 15A. When the diffraction efficiency is 1.2 times due to the effect of the dielectric film of the present embodiment, in a case where an image having the same brightness is visually recognized by the user, the power consumption of the light source can be reduced by 20% as compared with a case where there is no dielectric film. It is found that the refractive index of the dielectric material may be 1.64 or more when this condition is the condition under which the effect of the present embodiment becomes apparent.

As a thin film material suitable for the present embodiment, dielectric materials such as ZnS, AlN, SiNx, SiO, AlON, and Al₂O₃ can be used, and a mixed material of two or more dielectrics such as ZnS—SiO₂ (20%) can also be used. As a known dielectric material, diamond has the highest refractive index (2.42), and as illustrated in FIG. 15A, the upper limit of the refractive index of the dielectric thin film suitable for the present embodiment is 2.42.

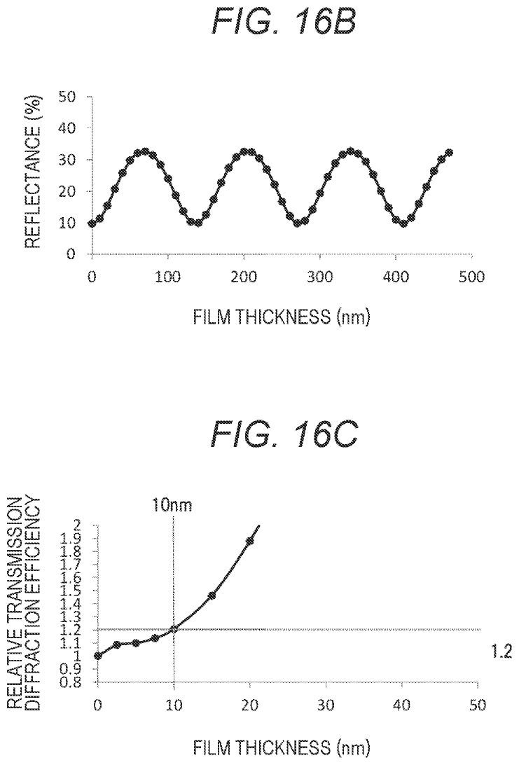

FIG. 16A is a simulation result showing a film thickness range of a dielectric material suitable for the present embodiment. The dielectric material is ZnS (refractive index 2.355). In the drawing, the vertical axis represents normalized transmission diffraction efficiency related to improvement in luminance at the center of the projection image. As can be seen from the drawing, it is found that as the film thickness of the dielectric film formed on the emission diffraction grating increases, the transmission diffraction efficiency increases, and there is an effect of improving the luminance of the visually recognized image. When the film thickness is about 70 nm or more, diffraction efficiency of about 3 times or more that in the case of no film is obtained.

FIG. 16B illustrates the film thickness dependence of the reflectance of a dielectric thin film formed on a flat substrate, a so-called optical thin film coating. Here, similarly to the above, the refractive index of the substrate is set to 1.58, ZnS is selected as the dielectric material, and the relationship between the film thickness and the reflectance is calculated. As can be seen in the drawing, it can be seen that the reflectance periodically changes with respect to the film thickness. Such film thickness dependency of the dielectric thin film is well known. On the other hand, as illustrated in FIG. 16A, the dielectric thin film on the diffraction grating is characterized in that a monotonically increasing component of diffraction efficiency with respect to an increase in film thickness is included in addition to periodicity. Such findings are not disclosed in a known technique for handling a head mounted display, and are characteristics found by the inventors.

FIG. 16C is an enlarged view of FIG. 16A. It is found that the film thickness of the dielectric material may be 10 nm or more when the condition that the diffraction efficiency becomes 1.2 times or more by the effect of the present embodiment is the condition that the effect of the present embodiment becomes apparent. However, in the present embodiment, as illustrated in FIG. 12, it is necessary that the dielectric thin film formed on the diffraction grating is formed along the uneven shape of the original diffraction grating, and it is also known that when the film thickness exceeds 10 times (approximately 1000 nm) the height (approximately 100 nm) of the uneven pattern, the uneven shape of the surface of the dielectric thin film is gradually lost and the surface of the dielectric thin film gradually approaches flat depending on a film forming process such as a sputtering method or a vacuum vapor deposition method. Therefore, the upper limit of the film thickness at which the effect of the present embodiment appears is about 1000 nm.

### Third Embodiment

In the third embodiment, a dielectric thin film suitable for the incident diffraction grating 101 will be examined. The incident diffraction grating 101 described below is a reflection-type diffraction grating, and includes a multilayer coating layer on the reflection-type diffraction grating. The multilayer coating layer has a periodic structure in which a first dielectric thin film and a second dielectric thin film are alternately formed, so that excellent wavelength dependency can be obtained.

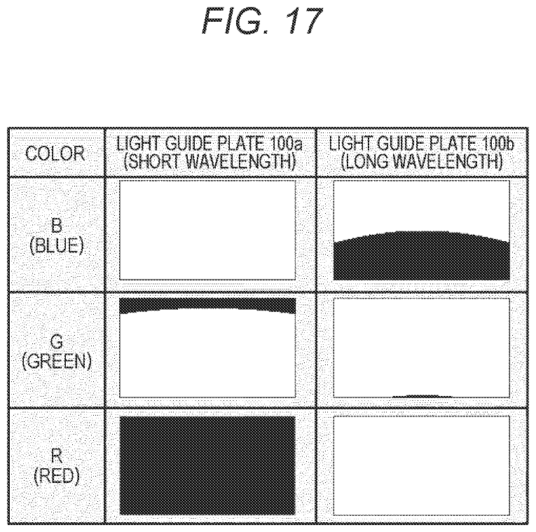

FIG. 17 is a simulation result of the range of the display image for each light guide plate. Here, a case of a light guide plate including two light guide plates 100a (for short wavelength) and 100b (for long wavelength) as illustrated in FIG. 6 will be described. The pitch of the incident/emission diffraction grating is 360 nm for the light guide plate 100a (for short wavelength) and 460 nm for the light guide plate 100b (for long wavelength), the diagonal viewing angle of the display image is 35 degrees, and the aspect ratio is 16:9. As illustrated in the screen image in FIG. 17, it can be seen that the display ranges (indicated by white portions in the drawing) of the images of the light guide plates are different.

In such a configuration, when the color of the display image is generally R (red) G (green) B (blue), the light guide plate 100a contributes to display of a part of the B image (blue display image) and the G image (green display image), and the light guide plate 100b contributes to display of a part of the G image (green display image) and the R image (red display image). It can be seen that the incident diffraction grating 101a provided on the light guide plate 100a in FIG. 6 desirably reflects and diffracts the B wavelength (blue wavelength) with high diffraction efficiency, reflects and diffracts the G wavelength (green wavelength) with diffraction efficiency smaller than that, and substantially transmits the R wavelength (red wavelength). This means that strong wavelength dependency on diffraction efficiency is required.

In general, a dichroic film is known as an optical element that reflects light beams having a short wavelength and transmits light beams having a long wavelength, and can be realized by a dielectric multilayer thin film formed on a transparent substrate. However, as illustrated in FIG. 16A, the dielectric thin film formed on the surface-uneven diffraction grating exhibits film thickness dependency different from that of a general optical thin film. Here, conditions of a dielectric thin film suitable for being formed on the incident diffraction grating will be described. The main performance indicators of the light guide plate 100a (for short wavelength) are reflection first-order diffraction efficiency and transmittance.

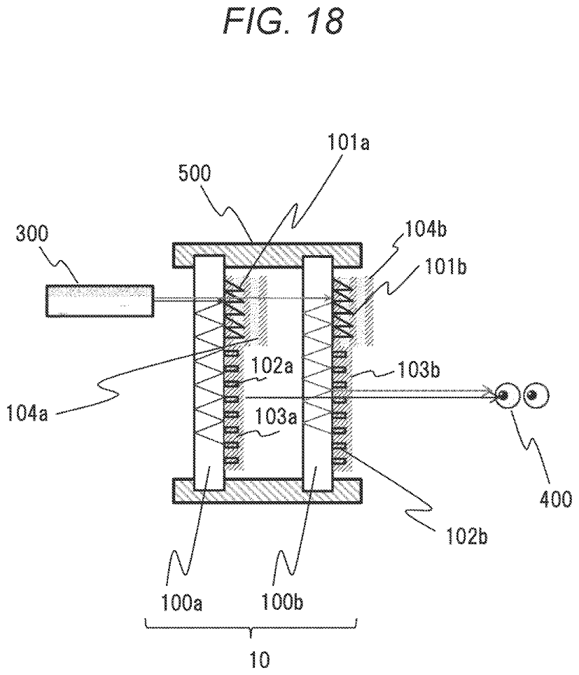

FIG. 18 illustrates another configuration of the image display element of the present embodiment. Here, an image display element 10 includes two light guide plates 100a and 100b, and incident diffraction gratings 101a and 101b and emission diffraction gratings 102a and 102b are formed, respectively. The incident diffraction gratings 101a and 101b are linear or lattice-shaped surface-concavo-convex diffraction gratings. The pattern periods of the emission diffraction gratings 102a and 102b are the same as those of the incident diffraction gratings 101a and 101b, respectively.

Coating layers 103a and 103b are formed on the surfaces of the emission diffraction gratings 102a and 102b, respectively. The light guide plates 100a and 100b have different pattern periods P1 and P2, respectively, and have different corresponding wavelength ranges. In a case where P1<P2, the light guide plate 100a mainly functions for display on the short wavelength side of the wavelength range of the color image, and the light guide plate 100b mainly functions for display on the long wavelength side. In FIG. 18, a difference in configuration from FIG. 6 is that coating layers 104a and 104b are formed of dielectric films also on the incident diffraction gratings 101a and 101b.

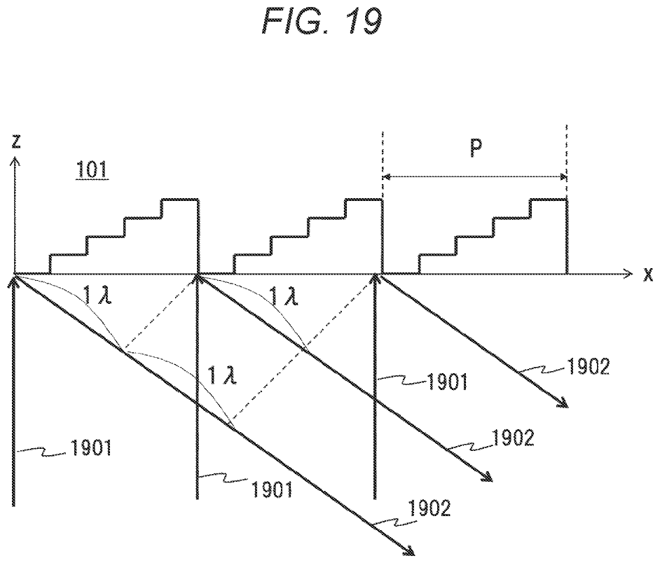

FIG. 19 is a schematic view illustrating a cross-sectional shape of the reflection-type incident diffraction grating 101. As illustrated in FIG. 9, a reflection-type incident diffraction grating is suitable for the light guide plate of the present embodiment. Here, a stepped concavo-convex diffraction grating having a cross-sectional shape at a height of 5 levels is illustrated. In the drawing, a point having the lowest height of the uneven shape is z=0, and the x direction is a periodic direction of the diffraction grating. The pitch of the diffraction grating is P, and the wavelength of the light beam is A.

The incident light 1901 incident from the lower side of the paper surface is first-order reflected and diffracted in the lower right direction of the paper surface to become diffracted light 1902. As illustrated in the drawing, the incident light 1901 incident apart by the pitch P has an optical path difference of 1λ in the diffraction direction. Since all of these diffracted light have a phase difference of 1λ (=2π), they are diffracted in a specific direction (direction in which the period P corresponds to the wavelength A) by mutual intensification. This is a widely known basic principle of diffraction. In order to consider a dielectric coating suitable for the incident diffraction grating 101 of the present embodiment, this basic principle is extended in the height z direction of the diffraction grating.

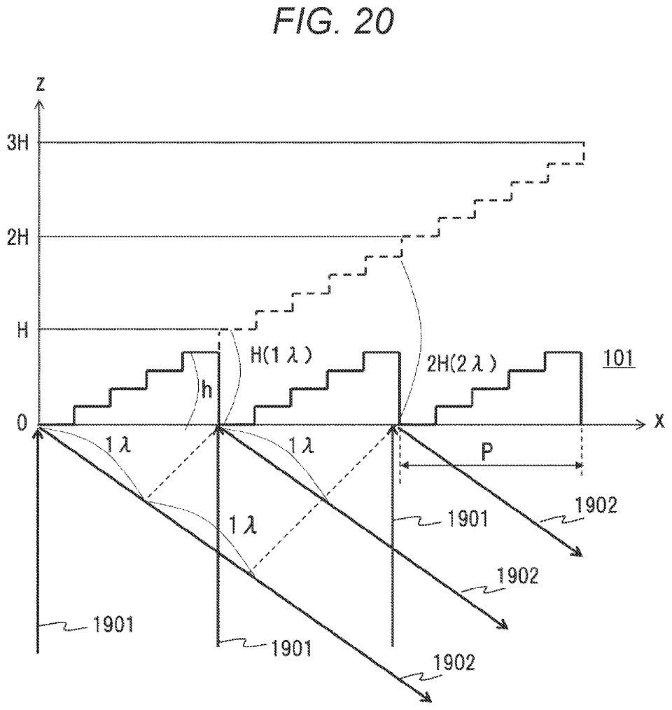

FIG. 20 is a schematic view for considering a dielectric coating suitable for the present embodiment. As described above, for the diffracted light 1902, the pitch P of the incident diffraction grating 101 is determined corresponding to the wavelength A to be selected. A broken line in the drawing is obtained by periodically expanding the shape of the diffraction grating subjected to height modulation. The height of the point shifted by one period P in the x direction is different by H. Here, H is defined as a period height of the incident diffraction grating 101. Similarly, diffracted light of the same angle is generated from the virtual diffraction grating having a broken line shape, and the period height H of the diffraction grating corresponds to the wavelength A with respect to the diffracted light.

Assuming that the maximum height of the actual diffraction grating is h, H=5 h/4 in this example. As the dielectric coating suitable for the incident diffraction grating 101 of the present embodiment, at least two types of materials including a material having a high refractive index (refractive index n1, film thickness d1) and a material having a low refractive index (refractive index n2, film thickness d2) are used, and these materials are alternately stacked on the diffraction grating. At this time, a dielectric layer reflecting the surface-uneven shape of the diffraction grating is formed above the surface of the diffraction grating in the z direction. A condition suitable for the present embodiment is d1+d2≈H. At this time, a boundary of the dielectric layer is formed along a broken line in FIG. 20, and the diffracted light 1902 generated from these can be intensified by a phase difference of 2 π. This is the basic concept of the dielectric coating formed on the incident diffraction grating of the present embodiment.

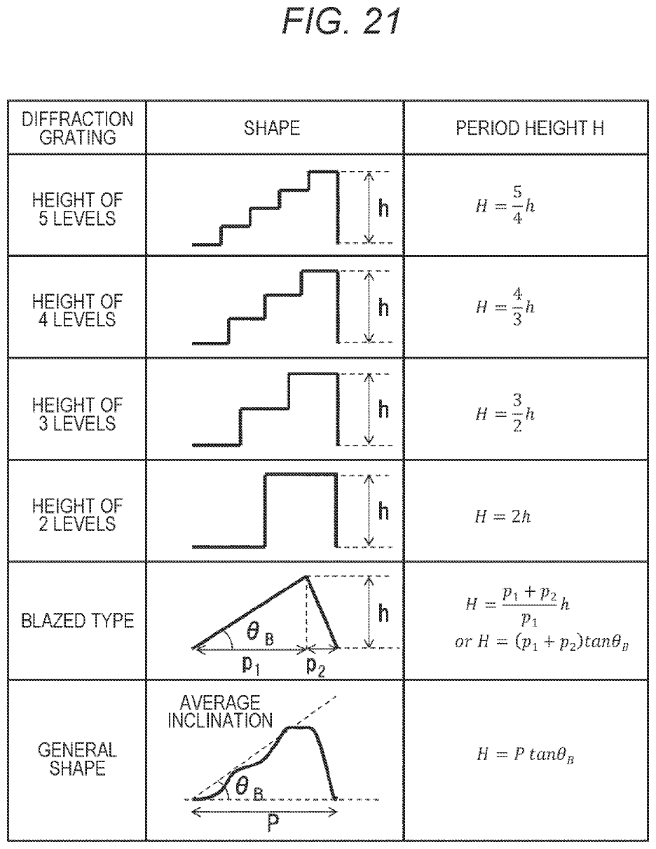

FIG. 21 summarizes the relationship between the period height H of the diffraction grating and the height shape of one period. As illustrated herein, in the stepped diffraction grating having the height of 5, 4, 3, or 2 levels, and the blazed diffraction grating, and the diffraction grating having a general shape, the period height H is defined as a value illustrated in the drawing. In the case of a stepped diffraction grating having an equal width as illustrated in the drawing, when the height is N level and the maximum height is h, H=(N/N−1) h.

In the blazed diffraction grating, as illustrated in the drawing, the period height H is obtained by extending the height from the inclination of the main blaze surface to one period. The so-called blaze angle is θ_{B}. At this time, H={(p₁+p₂)/p₁} h.

Similarly, when the blaze angle θ_{B} is determined from the average inclination in the diffraction grating having the general shape, H=P·tan θ_{B} is obtained when the diffraction grating period is P.

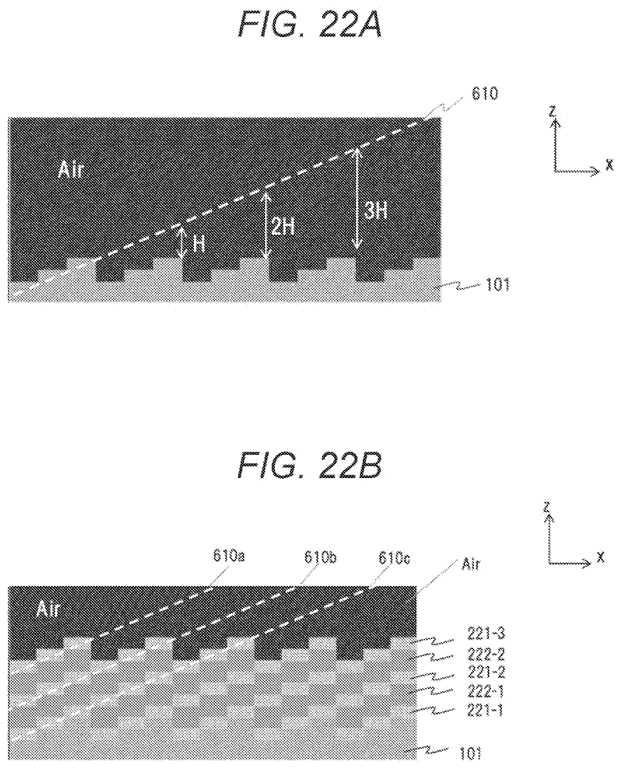

FIG. 22A is a simulation model illustrating a cross-sectional shape of the incident diffraction grating 101 of the present embodiment. A case where a diffraction grating having a height of 3 levels is formed as surface unevenness on a plastic substrate by an injection molding method or the like is shown. The auxiliary line in the drawing represents the above-described equiphase line 610 in the height direction, and shifts one period to the right in the X direction in the drawing due to the periodicity of the diffraction grating, whereby the distance between the equiphase line 610 and the uneven pattern in the Z direction increases at equal intervals by the period height H like H, 2H, and 3H. In this model, the height h of the diffraction grating is 100 nm and the period is 360 nm. The plastic substrate constituting the incident diffraction grating 101 has a refractive index of 1.58 and a period height H of 150 nm when the substrate is polycarbonate. A black portion in the drawing is an air layer (Air).

FIG. 22B is a simulation model illustrating a cross-sectional shape of the incident diffraction grating 101 of the present embodiment. Here, a case is illustrated in which a first dielectric film 221 (refractive index n1, thickness d1) having a high refractive index and a second dielectric film 222 (refractive index n2, thickness d2) having a low refractive index are alternately formed on the incident diffraction grating 101 in the order of 221-1, 222-1, 221-2, 222-2, and 221-3, and five dielectric thin films are stacked. Here, n1>n2 and d1+d2=H. Under such conditions, the diffraction grating group formed in the z direction by the dielectric layer can be formed to be aligned on equiphase surfaces 610a, 610b, 610c, and the like. As described above, the diffracted light generated from these diffraction grating groups is phase-matched, and a large diffraction efficiency can be obtained. In the simulation, ZnS—SiO₂ (20%) is selected as the first dielectric film 221, n1=2.33, d1=55 nm, and SiO₂ is selected as the second dielectric film 222, n2=1.47, d2=95 nm. The pitch of the diffraction grating is determined according to a selected wavelength (here, blue light).

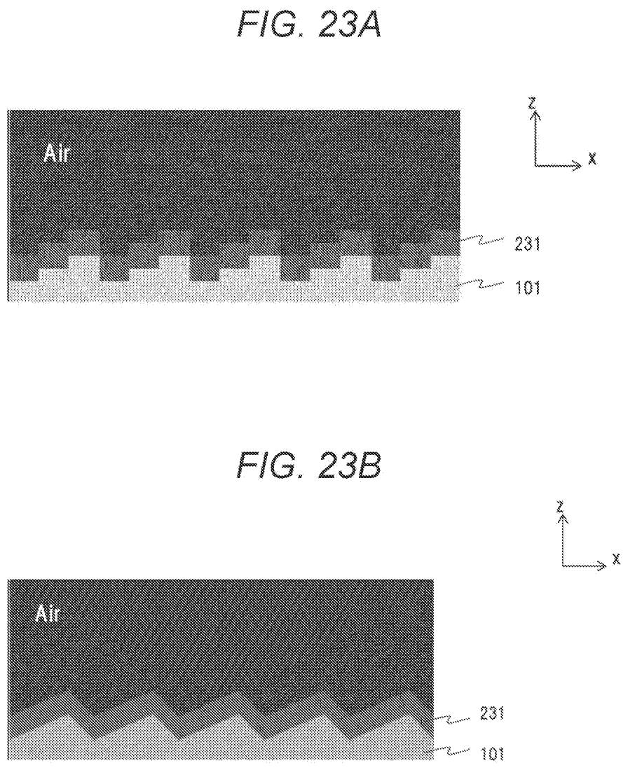

FIG. 23A is a simulation model in a case where an Al film 231 having a thickness of 100 nm is stacked on the incident diffraction grating 101 having a height of 3 levels as a reference.

FIG. 23B is a simulation model in a case where the Al film 231 of 100 nm is stacked on a blazed incident diffraction grating 101 as a reference.

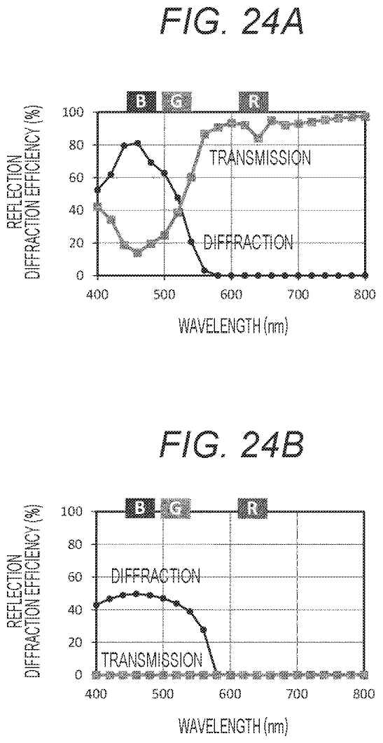

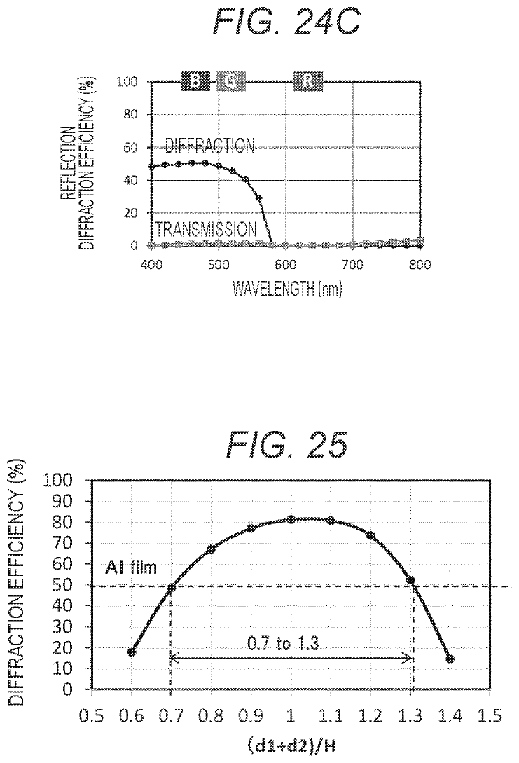

FIG. 24A is a simulation result of reflection first-order diffraction efficiency and transmittance of an incident diffraction grating in which five dielectric thin films are formed on a diffraction grating at a height of 3 levels of the present embodiment illustrated in FIG. 22B. Here, the case of an incident angle of 0 degrees corresponding to the center of the display image is calculated. As can be seen in the drawing, the reflection first-order diffraction efficiency is large from the B (Blue, 460 nm) wavelength band to the G (Green, 530 nm) wavelength band, is 0 in the R (Red, 640 nm) wavelength band, and is about 80% at the maximum in the B wavelength band. In addition, the transmittance is about 20% in the B wavelength band and 80% or more in the R wavelength band, and thus, it is understood that the wavelength dependency suitable for the light guide plate 100a for a short wavelength described in FIG. 18 can be provided.

FIG. 24B is a simulation result of the incident diffraction grating in which an Al thin film is formed on the diffraction grating at the height of 3 levels illustrated in FIG. 23A. The diffraction efficiency in the B wavelength band is about 50%, and the transmittance is almost 0 in the entire wavelength range.

FIG. 24C is a simulation result of the incident diffraction grating in which the Al thin film is formed on the blazed diffraction grating illustrated in FIG. 23B. The diffraction efficiency in the B wavelength band is about 50%, and the transmittance is almost 0 in the entire wavelength range.

As described above, according to the present embodiment, it has been found that the incident diffraction grating in which the dielectric film is stacked can achieve both higher diffraction efficiency and higher transmittance in a long wavelength band than the blazed diffraction grating in which the Al reflection film is formed. This is a performance characteristic suitable as the incident diffraction grating of the light guide plate.

FIG. 25 is a simulation result in a case where the total thickness (d1+d2) deviates from the period height H with respect to the dielectric thin film of FIG. 22B. Here, the result of calculating the reflection first-order diffraction efficiency in the B wavelength band by changing the film thickness d2 of the second dielectric film 222 is illustrated. The axis is (d1+d2)/H, and a case where this value is 1 is a condition of phase matching. As described above, the diffraction efficiency is about 50% when the Al reflection film is formed on the incident diffraction grating. When the condition under which diffraction efficiency higher than this value can be obtained is defined as the condition under which the effect of the present embodiment becomes apparent, it is found that the range of (d1+d2)/H is approximately 0.7 to 1.3. That is, 0.7H<d1+d2<1.3H.

As described above, in the multilayer dielectric coating of the present embodiment, the period height H of the diffraction grating corresponds to the phase 2n (360 degrees) of the light beam. Therefore, in the condition range shown here, the phase difference corresponds to ±110, and it can be said that a reasonable result is obtained even in light of the wave superposition condition.

Although the light guide plate 100a for a short wavelength has been described above, a similar effect can be obtained by setting the pitch of the diffraction grating for the light guide plate 100b for a long wavelength according to the wavelength (for example, red light) to be selected.

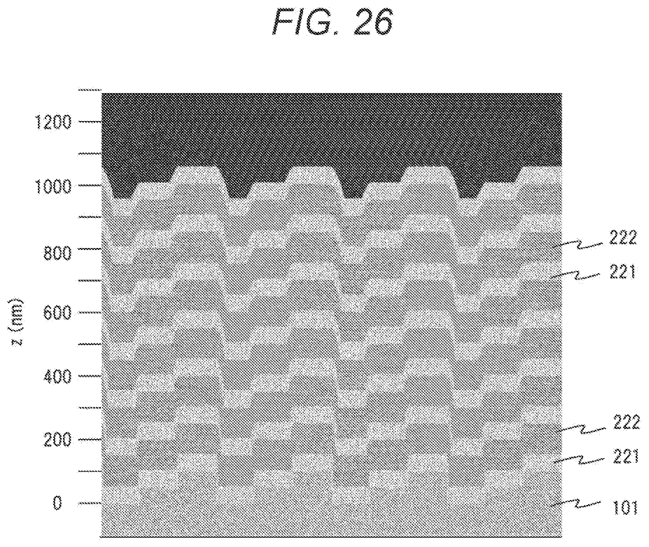

FIG. 26 is a schematic view illustrating a film shape when 13 dielectric thin films of the present embodiment are stacked. As described above, in a case where the first dielectric film 221 and the second dielectric film 222 are sequentially stacked on the incident diffraction grating 101 formed of plastic by a vacuum vapor deposition method, a sputtering method, or the like, a certain amount of dielectric material is also stacked on the sidewall of the diffraction grating configured by the uneven pattern formed on the surface of the plastic substrate. As a result, the shape of the dielectric film gradually changes in the layer on the lower side of the paper surface and the layer on the upper side of the paper surface. For this reason, in the dielectric film of the present embodiment, there is an upper limit on the total thickness. The upper limit value is about 10 times the height of the uneven pattern, and is about 1000 nm as described above. When the dielectric film has three layers, the period height H is 5 nm, d1 is 2 nm, and d2 is 3 nm with respect to the minimum value of the film thickness, the thickness is 7 nm. Therefore, the minimum value may be about 10 nm as described above.

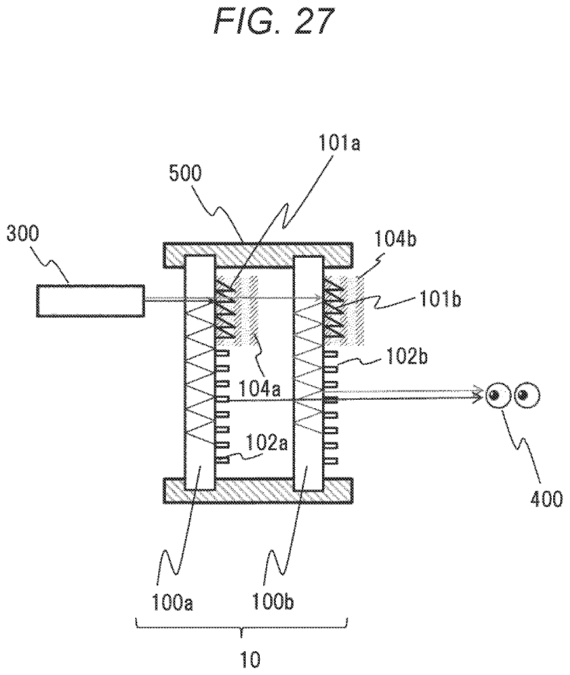

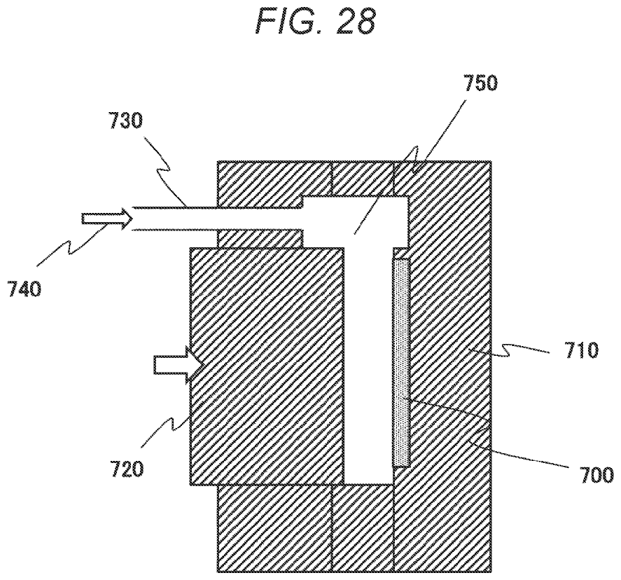

FIG. 27 is a diagram illustrating an example of an image display element in which a coating layer 104 is provided on the incident diffraction grating 101 and is not provided on the emission diffraction grating 102. In the incident diffraction grating 101, the effect of the dielectric film can be obtained.

### Fourth Embodiment

FIG. 28 is a schematic view of a method for integrally molding a diffraction grating on both surfaces of the light guide plate illustrated in FIG. 1 by a plastic molding technique. Production of a conventionally used light guide plate such as a nanoimprint method or etching is a surface processing technique based on a semiconductor processing technique. On the other hand, since the plastic molding technique such as an injection molding method is a three-dimensional molding technique by introducing a resin into a mold and solidifying the resin, it is easy to form diffraction gratings on both surfaces of the light guide plate.

In the drawing, a stamper 700 having a surface shape of the diffraction grating to be formed on the surface thereof in a form in which unevenness are inverted is fixed to a fixing portion 710 of the mold. By using such a mold, by injecting a molten resin 740 from a resin flow path 730 and moving a mold movable portion 720 in the right direction in the drawing, pressure is applied, so that the resin 740 can be formed into the shape along the shape of a cavity 750, and a desired light guide plate can be created through the cooling process. This method is general, and a light guide plate in which a diffraction grating is formed in an uneven shape can be made of plastic.

### Fifth Embodiment

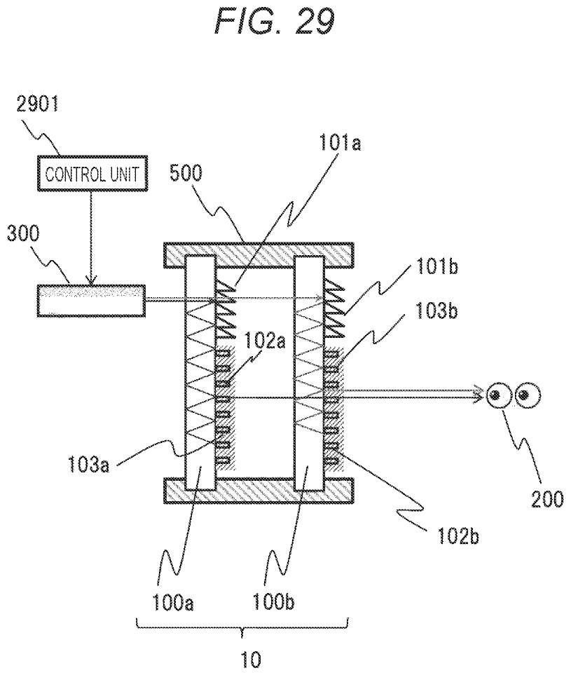

FIG. 29 is a schematic view illustrating a configuration of an image display device of the present embodiment.

In this image display device, plastic is used as a material of the light guide plate 100. As described with reference to FIG. 9, since it is difficult to form a pattern having a high aspect ratio in the incident diffraction grating having high diffraction efficiency, a reflection-type diffraction grating having a low aspect ratio is used as the incident diffraction grating 101. Since the reflection-type incident diffraction grating reflects light into the light guide plate 100, the incident diffraction grating 101 is disposed on a surface (second surface) of the light guide plate 100 on an opposite side of an incident surface (first surface) of the video light beam.

In the case of using a plurality of light guide plates 100, as described in FIGS. 10A and 10B, in order to reduce the deviation of the visually recognized pixel position, a transmission-type optical configuration in which light is emitted to the opposite side (second surface) to the incident surface (first surface) of the light beam is desirable as illustrated in FIG. 29.

As described above, the light guide plate 100 has a configuration in which the user visually recognizes the light in which the first-order reflection diffraction is dominant, so that the visual luminance can be increased at a low aspect ratio. Therefore, in a case where the diffraction efficiency is emphasized, the emission diffraction grating is preferably disposed on the first surface such that the first-order reflection diffracted light is emitted to the second surface. However, since the process of forming the diffraction gratings on both surfaces of the substrate is complicated, in the present embodiment, the emission diffraction grating 102 is also formed on the same surface (second surface), and the first-order transmitted diffracted light is emitted to the second surface.

In this case, since it is disadvantageous in terms of visual luminance, a configuration for improving luminance is important. In the present embodiment, the diffraction efficiency is improved by forming a dielectric film on the diffraction grating. As a specific configuration, if at least one of the incident diffraction grating 101 and the emission diffraction grating 102 has a film, improvement in luminance can be expected eventually. In the present embodiment, the coating layer 103 is formed on the emission diffraction grating 102 as in FIG. 6. In addition, it is also possible to form the coating layer 104 on the incident diffraction grating 101 as illustrated in FIG. 27. Alternatively, it is also possible to form the coating layers 103 and 104 on both the incident diffraction grating 101 and the emission diffraction grating 102 as illustrated in FIG. 18. In the configuration of the image display element described above, it is necessary to improve reflection diffraction efficiency in the incident diffraction grating and to improve transmission diffraction efficiency in the emission diffraction grating.

As a configuration example of the incident diffraction grating 101, the multilayer dielectric film described in FIG. 22B is excellent in wavelength selectivity and effective. In addition, as a configuration example of the emission diffraction grating 102, the lattice-shaped diffraction grating illustrated in FIG. 3 can obtain high diffraction efficiency at a low aspect ratio.

However, the configuration of the image display element is not limited to the above, and various configurations of the incident diffraction grating and the emission diffraction grating are also conceivable. Even in that case, by controlling the characteristics of the film to be formed according to the reflection diffraction efficiency and the transmission diffraction efficiency required for each of the incident diffraction grating and the emission diffraction grating, the diffraction efficiency can be improved and the luminance can be improved.

The light having the image information emitted from the projector 300 in the drawing is reached to the user's pupil 400 by the action of the light guide plates 100a and 100b to realize augmented reality. In each of the light guide plates 100a and 100b, the pitch and depth of the diffraction grating to be formed are optimized according to each color.

In the drawing, the image display device of the present embodiment includes the image display element 10, the projector 300, and a display image control unit 2901. In addition, as an image forming method, for example, widely known image forming apparatuses such as an image forming apparatus including a reflection-type or transmission-type spatial light modulator, a light source, and a lens, an image forming apparatus using an organic and inorganic electro luminescence (EL) element array and a lens, an image forming apparatus using a light emitting diode array and a lens, and an image forming apparatus combining a light source, a semiconductor MEMS mirror array, and a lens can be used.

In addition, it is also possible to use an LED or a laser light source and a tip of an optical fiber resonantly moved by MEMS technology, PZT, or the like. Among them, the most common is an image forming apparatus including a reflection-type or transmission-type spatial light modulator, a light source, and a lens. Here, examples of the spatial light modulation device can include a transmission-type or reflection-type liquid crystal display device such as liquid crystal on silicon (LCOS), and a digital micromirror device (DMD), and as the light source, a white light source can be separated into RGB, and an LED or a laser corresponding to each color can be used.

Further, the reflection-type spatial light modulation device may include a liquid crystal display device and a polarization beam splitter that reflects a part of light from a light source and guides the light to the liquid crystal display device, and passes a part of light reflected by the liquid crystal display device and guides the light to a collimating optical system using a lens. Examples of the light emitting element constituting the light source include a red light emitting element, a green light emitting element, a blue light emitting element, and a white light emitting element. The number of pixels may be determined on the basis of specifications required for the image display device, and 320×240, 432×240, 640×480, 1024×768, and 1920×1080 can be exemplified as specific values of the number of pixels in addition to 1280×720 described above.

In the image display device of the present embodiment, a light beam including video information emitted from the projector 300 is positioned so as to be emitted to each incident diffraction grating of the light guide plates 100a and 100b, and is formed integrally with the image display element 10.

In addition, the display image control unit (not illustrated) performs a function of controlling the operation of the projector 300 and appropriately providing image information to the user's pupil 400.

In the embodiment described above, in the light guide plate (image display element) having the surface-concavo-convex diffraction grating, for example, a mesh-type diffraction grating is used as the emission diffraction grating, and integrally molded with a material having the same refractive index as that of the waveguide by an injection molding method or the like, so that the light guide plate can be made plastic, and a safe and lightweight light guide plate can be realized. That is, by using the mesh-type diffraction grating, a light guide plate having good performance with surface unevenness of an aspect ratio of 1 or less can be produced by an injection molding method, and improvement in safety and weight reduction due to plasticization of the light guide plate can be realized.

In the present embodiment, the case of providing the image information to the user has been described. However, the image display device of the present embodiment can further include various sensors such as a touch sensor, a temperature sensor, and an acceleration sensor for acquiring information of the user and the outside world, and an eye tracking mechanism for measuring eye movement of the user.

### REFERENCE SIGNS LIST

100 light guide plate
101 incident diffraction grating
102 emission diffraction grating
300 projector

1. An image display element comprising:
a plastic substrate;
an incident diffraction grating integrally formed on a surface of the plastic substrate and configured to diffract incident video light;
an emission diffraction grating integrally formed on a surface of the plastic substrate and configured to emit the video light; and
a coating layer formed on the emission diffraction grating and having a thickness of 10 nm or more and 1000 nm or less and a refractive index of 1.64 or more and 2.42 or less.

2. The image display element according to claim 1, wherein
the incident diffraction grating and the emission diffraction grating are formed on an identical surface of the plastic substrate.

3. The image display element according to claim 1, wherein
the incident diffraction grating and the emission diffraction grating have an aspect ratio of 1 or less.

4. The image display element according to claim 1, wherein
the emission diffraction grating has a mesh shape.

5. The image display element according to claim 4, wherein
the emission diffraction grating is formed of an uneven pattern, and the uneven pattern includes a first group of parallel straight lines and a second group of parallel straight lines intersecting the first group of parallel straight lines,
a pitch of the first group of parallel straight lines and the second group of parallel straight lines is equal to P, and
W/P is 0.15 or more and 0.85 or less as a relationship between a pitch P of the first group of parallel straight lines and the second group of parallel straight lines and a width W of the uneven pattern.

6. The image display element according to claim 1, wherein
the coating layer has a film thickness of 70 nm or more.

7. The image display element according to claim 1, wherein
the coating layer has a film thickness of 25 nm or more and less than 35 nm.

8. The image display element according to claim 1, wherein
the coating layer includes at least one selected from ZnS, AlN, SiNx, SiO, AlON, Al₂O₃, ZnS—SiO₂, and diamond.

9. An image display element comprising:
a plastic substrate;
an incident diffraction grating integrally formed on a surface of the plastic substrate and configured to diffract incident video light;
an emission diffraction grating integrally formed on a surface of the plastic substrate and configured to emit the video light; and
a multilayer coating layer in which a first dielectric material having a film thickness d1 and a second dielectric material having a film thickness d2 are alternately stacked for N (N is a natural number) periods, d1+d2 is substantially equal to H, and (d1+d2)×N is 1000 nm or less, where H is a period height of an uneven pattern of the incident diffraction grating.

10. The image display element according to claim 9, wherein
when a refractive index of the first dielectric material is represented by n1 and a thickness is represented by d1, and a refractive index of the second dielectric material is represented by n2 and a thickness is represented by d2,
n1>n2 and 0.7H<d1+d2<1.3H,
the H is,
when the incident diffraction grating is a stepped diffraction grating, a height of which is N level and a maximum height of which is h,
H=(N/N−1)h,
when the incident diffraction grating is a blazed diffraction grating, a blaze angle of which is θ_{B}, and a diffraction grating period of which is p,
H=p·tan θ_{B}, and
when the incident diffraction grating is a diffraction grating having a general shape, a blaze angle obtained from an average inclination of the diffraction grating is θ, and a diffraction grating period is P,
H=P·tan θ.

11. An image display device comprising:
a projector that is a light source for forming video light;
a plastic substrate;
an incident diffraction grating integrally formed on a surface of the plastic substrate and configured to diffract incident video light;
an emission diffraction grating integrally formed on a surface of the plastic substrate and configured to emit the video light; and
a coating layer having a thickness of 10 nm or more and 1000 nm or less formed on the emission diffraction grating and a refractive index of 1.4 or more and 2.42 or less, wherein
the incident diffraction grating and the emission diffraction grating are formed on a first surface of the plastic substrate,
the projector is provided on a second surface side opposite to the first surface, and
video light can be visually recognized from the first surface side of the plastic substrate.

12. The image display device according to claim 11, wherein
the coating layer has a film thickness of 70 nm or more.

13. The image display device according to claim 11, wherein
the coating layer has a film thickness of 25 nm or more and less than 35 nm.

14. The image display device according to claim 11, wherein
the incident diffraction grating is a reflection-type diffraction grating, and includes a multilayer coating layer on the reflection-type diffraction grating, and
the multilayer coating layer has a periodic structure in which a first dielectric thin film and a second dielectric thin film are alternately formed.

15. The image display device according to claim 14, wherein
when a refractive index of the first dielectric thin film is represented by n1 and a thickness is represented by d1, and a refractive index of the second dielectric thin film is represented by n2 and a thickness is represented by d2,
n1>n2 and 0.7H<d1+d2<1.3H,
the H is,
when the incident diffraction grating is a stepped diffraction grating, a height of which is N level and a maximum height of which is h,
H=(N/N−1)h,
when the incident diffraction grating is a blazed diffraction grating, a blaze angle of which is θ_{B}, and a diffraction grating period of which is p,
H=p·tan θ_{B}, and
when the incident diffraction grating is a diffraction grating having a general shape, a blaze angle obtained from an average inclination of the diffraction grating is θ, and a diffraction grating period is P,
H=P·tan θ.
